(19) United States
(12) Patent Application Publication
(10) Pub. No.: US 2015/0200051 A1
(43) Pub. Date: Jul. 16, 2015

(54) TRANSFORMER DEVICE

(71) Applicant: DENSO CORPORATION, Kariya-city (JP)

(72) Inventor: Kazuhiro UMETANI, Nagoya-city (JP)

(21) Appl. No.: 14/591,104

(22) Filed: Jan. 7, 2015

(30) Foreign Application Priority Data
Jan. 10, 2014 (JP) 2014-3350

(51) Int. Cl. H01F 27/28; H01F 27/24

(52) U.S. Cl. CPC H01F 27/2823; H01F 27/24

(57) ABSTRACT

A transformer device includes a magnetic core, a normal winding, a main magnetic path, and a specific winding including A sections and B sections formed by winding a conductive wire around the magnetic core toward opposite directions. A total number of turns of the conductive wire is different between the A sections and the B sections. At least one section in the specific winding is arranged to form a sub-magnetic path which is a magnetic path not interlinked with the normal winding.

### CROSS REFERENCE TO RELATED APPLICATIONS

The present application is based on and claims priority to Japanese Patent Application No. 2014-3350 filed on Jan. 10, 2014, the contents of which are incorporated in their entirety herein by reference.

### TECHNICAL FIELD

The present disclosure relates to a transformer device.

### BACKGROUND

As an ignition system of an internal combustion engine, a high-frequency ignition system disclosed in JP-A-2012-502225 (corresponding to US 2011/0247599 A1) has been known. In the high-frequency ignition system, resonance of the inductance coil with a parasitic capacitance of a plug disposed on a secondary winding side through the transformer is excited, to thereby apply a very high voltage to the plug to generate discharge.

In this system, the high voltage is generated by the transformer having a secondary winding larger in the number of turns than a primary winding. Further, the voltage can increase due to a series resonance of the inductance coil and the parasitic capacitance. This system is suitable for generation of the very high voltage.

However, in the system, because two magnetic components of the transformer and the inductance coil are required, there arises such a problem that the device increases the size. As solution to the above problem, JP-A-2009-212157 (corresponding to US 2009/0219007 A1) discloses a transformer device used for a discharge tube lighting system in a liquid crystal monitor, and having the same resonance system as that described above. In the transformer device, the transformer and the inductance coil described above are integrated with a single magnetic core. Since the magnetic core is shared by the transformer and the inductance coil in this way, the magnetic core can be downsized, and a dead space between the magnetic components can be reduced, which is effective for downsizing.

However, in the transformer device of JP-A-2009-212157, because the secondary winding also serves as the winding of the transformer and the winding of the inductance coil in the transformer device of JP-A-2012-502225, the number of turns of the windings cannot be designed, independently.

In the system that generates the high voltage, if a Q value of the resonance is higher, because an applied voltage of the inductance coil is large as compared with the transformer, the inductance coil needs to have a very larger number of turns than that in the secondary wiring.

Accordingly, the number of turns of the secondary winding in the transformer device of JP-A-2009-212157 needs to be as large as that in the inductance coil. Accordingly, the number of turns of the primary winding needs to be increased. As a result, as compared with a case in which the transformer and the inductance coil are disposed individually, the number of turns of the primary winding of the transformer increases.

In general, in the transformer used for generation of the high voltage, because the number of turns of the conducive wire of the secondary winding is very larger than the number of turns of the primary winding, a current that flows in the primary winding is very larger than a current that flows in the secondary winding. Therefore, the primary winding is likely to become larger in copper loss than the secondary winding, and an increase in the number of turns of the primary winding is likely to lead to efficiency deterioration of the overall circuit.

### SUMMARY

It is an object of the present disclosure to provide a transformer device that can suppress the number of turns of windings.

A transformer device according to an aspect of the present disclosure includes a magnetic core configured by a single part or configured integrally by a plurality of parts, a normal winding having a conductive wire wound around the magnetic core, a main magnetic path interlinked with the normal winding, and a specific winding.

The specific winding includes one or a plurality of A sections formed on the main magnetic path by winding a conductive wire around the magnetic core toward a predetermined direction, and one or a plurality of B sections formed on the main magnetic path by winding the conductive wire around the magnetic core toward a direction opposite to the direction in the A sections.

A total number of turns of the conductive wire in all of the A sections is different from a total number of turns of the conductive wire in all of the B sections. At least one section in the specific winding is arranged to form a sub-magnetic path which is a magnetic path not interlinked with the normal winding.

When the normal winding of the transformer device is used as the primary winding, and the specific winding is used as the secondary winding, the number of turns of the secondary winding of the transformer on an equivalent circuit is smaller than the number of turns of the specific winding. Likewise, when the normal winding of the transformer device is used as the secondary winding, and the specific winding is used as the primary winding, the number of turns of the primary winding of the transformer on an equivalent circuit is smaller than the number of turns of the specific winding.

Accordingly, a turn ratio of the normal winding and the specific winding of the transformer device used as the primary winding or the secondary winding can be set to a required ratio while suppressing the number of turns of the normal winding.

### BRIEF DESCRIPTION OF THE DRAWINGS

Additional objects and advantages of the present disclosure will be more readily apparent from the following detailed description when taken together with the accompanying drawings. In the drawings:

FIG. 1 is a diagram illustrating a transformer device according to a first embodiment;

FIG. 2 is a circuit diagram of an equivalent circuit of the transformer device according to the first embodiment;

FIG. 3 is a circuit diagram of an AC/DC converter using the transformer device according to the first embodiment;

FIG. 4 is a circuit diagram of an equivalent circuit of the AC/DC converter using the transformer device according to the first embodiment;

FIG. 5 is a diagram illustrating a transformer device according to a second embodiment;

FIG. 6 is a diagram illustrating a transformer device according to a third embodiment;

FIG. 7 is a circuit diagram of a DC/DC converter using the transformer device according to the third embodiment;

FIG. 8 is a circuit diagram of an equivalent circuit of the DC/DC converter using the transformer device according to the third embodiment;

FIG. 9 is a diagram illustrating a transformer device according to a fourth embodiment;

FIG. 10 is a circuit diagram of a DC/DC converter using the transformer device according to the fourth embodiment;

FIG. 11 is a circuit diagram of an equivalent circuit of the DC/DC converter using the transformer device according to the fourth embodiment;

FIG. 12 is a diagram illustrating a transformer device according to a fifth embodiment;

FIG. 13 is a perspective view of a first base of the transformer device according to the fifth embodiment;

FIG. 14 is a circuit diagram of an equivalent circuit of a booster circuit using the transformer device according to the fifth embodiment;

FIG. 15 is a diagram illustrating a transformer device according to a sixth embodiment;

FIG. 16 is a circuit diagram of an inverter using the transformer device according to the sixth embodiment;

FIG. 17 is a circuit diagram of a booster circuit using a transformer device according to a seventh embodiment; and

FIG. 18 is a circuit diagram of an equivalent circuit of a booster circuit using the transformer device according to the seventh embodiment.

### DETAILED DESCRIPTION

Hereinafter, embodiments of the present disclosure will be described with reference to the accompanying drawings. The embodiments of the present disclosure are not limited to the following embodiments, but may be variously modified within a technical scope of the present disclosure.

without being limited by the following embodiments

### First Embodiment

### Description of Main Configuration

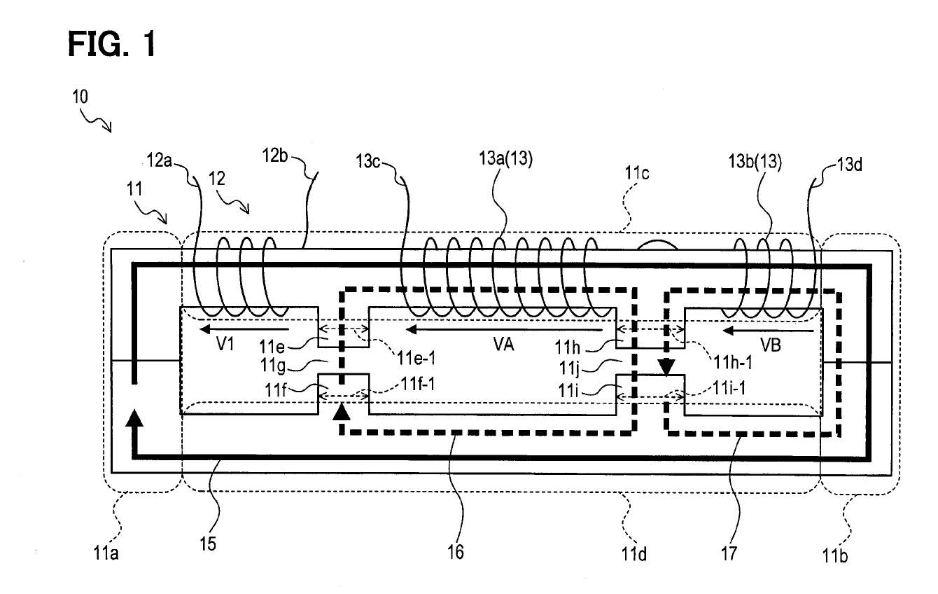

A transformer device 10 according to a first embodiment (see FIG. 1) is used in, for example, an ignition device for an internal combustion engine, a booster circuit in a liquid crystal monitor, a converter, an inverter, or a filter.

A magnetic core 11 of the transformer device 10 is formed in a substantially rectangular shape, and a hole that penetrates the magnetic core 11 is formed in the center of the magnetic core 11. In other words, the magnetic core 11 is configured to surround an inner space having a rectangular shape in a plan view along a contour of the rectangular shape.

Hereinafter, respective portions forming short sides in an outer peripheral portion of the magnetic core 11 are called “left short portion 11a” and “right short portion 11b”, and respective portions forming long sides in the outer peripheral portion are called “upper long portion 11c” and “lower long portion 11d”.

A first projection 11e and a second projection 11f, and a third projection 11h and a fourth projection 11i, which project inward, are disposed on inner peripheral sides of the upper long portion 11c and the lower long portion 11d. The first projection 11e and the second projection 11f are arranged at a predetermined distance from the left short portion 11a, and the third projection 11h and the fourth projection 11i are arranged at a distance similar to the predetermined distance.

The first projection 11e and the second projection 11f are arranged so that tip portions of the first projection 11e and the second projection 11f face each other in the inner space, and a gap 11g is formed between the tip portions. The third projection 11h and the fourth projection 11i are also arranged so that tip portions of the third projection 11h and the fourth projection 11i face each other in the inner space, and a gap 11j is formed between the tip portions.

A normal winding 12 is disposed at a position of the upper long portion 11c, which is sandwiched between the left short portion 11a and the first projection 11e. A specific winding 13 is disposed at a position of the upper long portion 11c, which is sandwiched between the first projection 11e and the right short portion 11b.

Further, the specific winding 13 includes an A section 13a arranged between the first projection 11e and the third projection 11h, and a B section 13b arranged between the third projection 11h and the right short portion 11b. In the A section 13a and the B section 13b, a direction of winding the conductive wire is different from each other.

Specifically, for example, it is assumed that a main magnetic path 15 which will be described later is formed on the upper long portion 11c from the left short portion 11a toward the right short portion 11b. In this case, the A section 13a is formed by winding the conductive wire clockwise toward a direction of the main magnetic path 15, and the B section 13b is formed by winding the conductive wire counterclockwise toward the direction. It is needless to say that the respective winding directions of the conductive wire in the A section 13a and in the B section 13b may be opposite to the directions described above.

The number of turns of the conducive wire in the A section 13a is larger than the number of turns of the conductive wire in the B section 13b. In this example, when a voltage is applied to the normal winding 12, a magnetic flux is generated by the normal winding 12. A portion of the magnetic path through which the magnetic flux passes, which is interlocked with all of the sections of the normal winding 12 and the specific winding 13 is called “main magnetic path 15”.

The main magnetic path 15 is formed along the outer peripheral portion (the upper long portion 11c, the right short portion 11b, the lower long portion 11d, the left short portion 11a) of the magnetic core 11. An orientation of the main magnetic path 15 in FIG. 1 is indicated as an orientation of the magnetic flux that is generated when a current flowing from a first terminal 12a toward a second terminal 12b is supplied to the normal winding 12.

When a voltage is applied to the specific winding 13, a magnetic flux is generated in each of the A section 13a and the B section 13b of the specific winding 13. A portion of the magnetic path of the magnetic flux generated in the A section 13a, which is not interlinked with the normal winding 12 is called “an A sub-magnetic path 16”. A portion of the magnetic path of the magnetic flux generated in the B section 13b, which is not interlinked with the normal winding 12 is called “a B sub-magnetic path 17”.

The A sub-magnetic path 16 is generated in a section of the upper long portion 11c of the magnetic core 11 from the first projection 11e to the third projection 11h, a section of the lower long portion 11d from the second projection 11f to the fourth projection 11i, the first projection 11e, the second projection 11f, the third projection 11h, and the fourth projection 11i.

Hereinafter, a portion in which the A sub-magnetic path 16 is formed is also called “A sub-magnetic path formation portion”. The B sub-magnetic path 17 is generated in a section of the upper long portion 11c of the magnetic core 11 from the third projection 11h to the right short portion 11b, a section of the lower long portion 11d from the fourth projection 11i to the right short portion 11b, the third projection 11h, the fourth projection 11i, and the right short portion 11b.

Hereinafter, a portion in which the B sub-magnetic path 17 is formed is also called “sub-magnetic path formation portion B”. The orientations of the A sub-magnetic path 16 and the B sub-magnetic path 17 in FIG. 1 are indicated as the orientation of the magnetic flux that is generated when the current flowing from a first terminal 13c toward a second terminal 13d is supplied to the specific winding 13.

[Operating Principle]

The operating principle of the transformer device 10 according to the first embodiment will be described below. In the following description, the normal winding 12 is used the primary winding, and the specific winding 13 is used as the secondary winding. It is assumed that the respective currents flowing in the primary winding (the normal winding 12) and the secondary winding (the specific winding 13) are I₁, I₂, the number of turns of the primary winding (the normal winding 12) is N₁, and the respective numbers of turns of the A section 13a and the B section 13b in the secondary winding (the specific winding 13) are N_{A}, N_{B}.

For simplification of a discussion, the magnetic core 11 has a sufficiently large permeability as compared with the gaps 11g and 11j on the A sub-magnetic path 16 and the B sub-magnetic path 17, and a magnetic field within the magnetic core 11 can be ignored.

The following expression is obtained by applying the Ampere's law against the main magnetic path 15.

[Expression 1]

N₁I₁+(N_{A}−N_{B})I₂=∫Hdl (1)

It is assumed that H is the intensity of a magnetic field, I is a line element, and integration is performed in the main magnetic path 15. In the transformer device 10, because the main magnetic path 15 is formed in the magnetic core 11, it can be considered that a value of a right side in Expression 1 is very small, and almost negligible. Accordingly, the following expression can be derived from Expression 1.

[Expression 2]

N₁I₁+(N_{A}−N_{B})I₂=0 (2)

In the transformer device 10, because the main magnetic path 15 is formed in the magnetic core 11, the right side of Expression 1 is negligible. In general, if a magnetic resistance of the main magnetic path is sufficiently small, the right side of Expression 1 can be considered to be small, and the same argument is established.

Then, the Ampere's law is similarly applied against the A sub-magnetic path 16 and the B sub-magnetic path 17. As a result, the following expression is obtained.

[Expression 3]

N_{A}I₂=R₁φ_{A}+R₂(φ_{A}+φ_{B}) (3)

[Expression 4]

N_{B}I₂=R₂(φ_{A}+φ_{B})+R₃φ_{B} (4)

In the expressions, magnetic fluxes φ_{A} and φ_{B} are magnetic fluxes of the A sub-magnetic path 16 and the B sub-magnetic path 17, respectively. It is assumed that orientations of the magnetic flux when the magnetic fluxes φ_{A} and φ_{B} have positive values are orientations indicated by arrows in FIG. 1.

A magnetic resistance R₁ is a magnetic resistance of a portion of the A sub-magnetic path formation portion in which the A sub-magnetic path 16 is formed, which is not shared with the B sub-magnetic path 17. A magnetic resistance R₂ is a magnetic resistance of a portion of the magnetic core 11 in which the A sub-magnetic path 16 and the B sub-magnetic path 17 are formed (an overlap portion of the A sub-magnetic path formation portion and the B sub-magnetic path formation portion).

A magnetic resistance R₃ is a magnetic resistance of a portion of the sub-magnetic path formation portion B where the B sub-magnetic path 17 is formed, which is not shared with the A sub-magnetic path 16. The following expression is obtained by solving the Expressions 3 and 4 for the magnetic fluxes φ_{A} and φ_{B}.

$$\begin{matrix}[ Expression 5 ] & \\ {φ}_{A} = \frac{{N}_{A} - \frac{{R}_{2}}{{R}_{2} + {R}_{3}} {N}_{B}}{{R}_{1} + {R}_{2} - \frac{{R}_{2}^{2}}{{R}_{2} + {R}_{3}}} {I}_{2} & ( 5 ) \\ [ Expression 6 ] & \\ {φ}_{B} = \frac{{N}_{B} - \frac{{R}_{2}}{{R}_{1} + {R}_{2}} {N}_{A}}{{R}_{2} + {R}_{3} - \frac{{R}_{2}^{2}}{{R}_{1} + {R}_{2}}} {I}_{2} & ( 6 )\end{matrix}$$

Then, the Faraday's law is applied to the A sub-magnetic path 16 and the B sub-magnetic path 17. If the respective voltages induced in the A section 13a and the B section 13b of the secondary winding (the specific winding 13) when it is assumed that the magnetic flux of the main magnetic path 15 is 0 are V_{A} and V_{B}, the following expression is obtained according to the Faraday's law.

It is assumed that the orientations of the arrows described in the A section 13a and the B section 13b in FIG. 1 are orientations of the voltages when V_{A} and V_{B} have positive values.

$$\begin{matrix}[ Expression 7 ] & \\ {V}_{A} = {N}_{A} \frac{d {φ}_{A}}{d t} & ( 7 ) \\ [ Expression 8 ] & \\ {V}_{B} = {N}_{B} \frac{d {φ}_{B}}{d t} & ( 8 )\end{matrix}$$

The following expression is obtained by substituting Expressions 5 and 6 into Expressions 7 and 8.

$$\begin{matrix}[ Expression 9 ] & \\ {V}_{A} = {N}_{A} \frac{{N}_{A} - \frac{{R}_{2}}{{R}_{2} + {R}_{3}} {N}_{B}}{{R}_{1} + {R}_{2} - \frac{{R}_{2}^{2}}{{R}_{2} + {R}_{3}}} \frac{d {I}_{2}}{d t} & ( 9 ) \\ [ Expression 10 ] & \\ {V}_{B} = {N}_{B} \frac{{N}_{B} - \frac{{R}_{2}}{{R}_{1} + {R}_{2}} {N}_{A}}{{R}_{2} + {R}_{3} - \frac{{R}_{2}^{2}}{{R}_{1} + {R}_{2}}} \frac{d {I}_{2}}{d t} & ( 10 )\end{matrix}$$

Finally, when the magnetic flux of the main magnetic path 15 is φ_{M}, an induced voltage of the secondary winding (the specific winding 13) is obtained as follows.

$$\begin{matrix} [ Expression 11 ] & \\ \begin{matrix}{V}_{2} = {V}_{A} + {V}_{B} + ( {N}_{A} - {N}_{B} ) \frac{d {φ}_{M}}{d t} \\ = ( {N}_{A} \frac{{N}_{A} - \frac{{R}_{2}}{{R}_{2} + {R}_{3}} {N}_{B}}{{R}_{1} + {R}_{2} - \frac{{R}_{2}^{2}}{{R}_{2} + {R}_{3}}} + {N}_{B} \frac{{N}_{B} - \frac{{R}_{2}}{{R}_{1} + {R}_{2}} {N}_{A}}{{R}_{2} + {R}_{3} - \frac{{R}_{2}^{2}}{{R}_{1} + {R}_{2}}} ) \frac{d {I}_{2}}{d t} + \\ \frac{( {N}_{A} - {N}_{B} )}{{N}_{1}} {V}_{1}\end{matrix} & ( 11 )\end{matrix}$$

In the Expression 11, V₁ is a voltage applied to the primary winding (the normal winding 12), and V₂ is an induced voltage of the secondary winding (the specific winding 13). The V₁=N₁dφ_{M}/dt is used according to the Faraday's law.

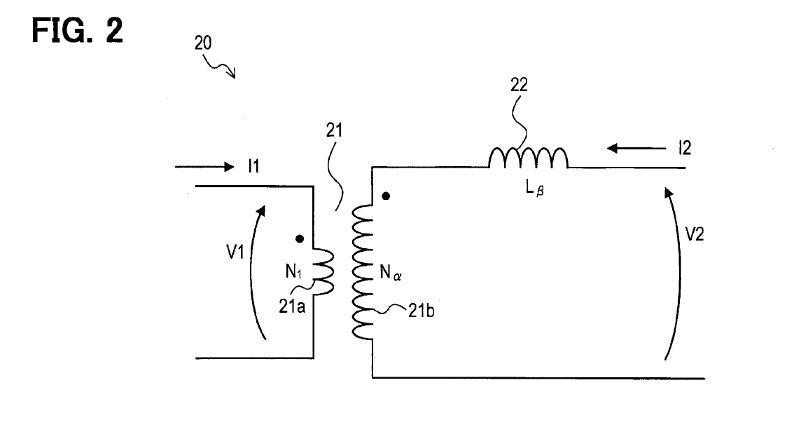

On the other hand, Expressions 12 and 13 are obtained by considering a relational expression of a voltage V₁ applied to a primary winding 21a of a transformer 21, a current I₁ flowing in the primary winding 21a, and a voltage I₂ developed in a secondary winding 21b and an inductor 22, and a current I₂ flowing into the secondary winding 21b and the inductor 22 in a circuit 20 of FIG. 2.

$$\begin{matrix}[ Expression 12 ] & \\ {V}_{2} = {L}_{β} \frac{d {I}_{2}}{d t} + \frac{{N}_{α}}{{N}_{1}} {V}_{1} & ( 12 ) \\ [ Expression 13 ] & \\ {I}_{2} = - \frac{{N}_{α}}{{N}_{1}} {I}_{1} & ( 13 )\end{matrix}$$

In the expressions, the number of turns of the primary winding 21a in the transformer 21 is N₁, the number of turns of the secondary winding 21b is N_{α}, and an inductance of the inductor 22 is L_{β}. When Expressions 1 and 11 are compared with Expressions 12 and 13, it is found that a structure of the transformer device 10 according to the present embodiment is equivalent to the circuit 20.

$$\begin{matrix}[ Expression 14 ] & \\ {L}_{β} = {N}_{A} \frac{{N}_{A} - \frac{{R}_{2}}{{R}_{2} + {R}_{3}} {N}_{B}}{{R}_{1} + {R}_{2} - \frac{{R}_{2}^{2}}{{R}_{2} + {R}_{3}}} + {N}_{B} \frac{{N}_{B} - \frac{{R}_{2}}{{R}_{1} + {R}_{2}} {N}_{A}}{{R}_{2} + {R}_{3} - \frac{{R}_{2}^{2}}{{R}_{1} + {R}_{2}}} & ( 14 ) \\ [ Expression 15 ] & \\ {N}_{α} = {N}_{A} - {N}_{B} & ( 15 )\end{matrix}$$

Advantages obtained by the transformer device 10 of the first embodiment will be discussed on the basis of the above results. First, as is apparent from Expression 15, the number of turns N_{α} of the secondary winding in the transformer 21 of the equivalent circuit 20 is a value smaller than a total number (N_{A}+N_{B}) of turns of the secondary winding (the specific winding 13) of the transformer device 10.

Therefore, if the turn ratio of the primary winding and the secondary winding is the same, the number of turns of the primary winding can be reduced as compared with the transformer device in JP-A-2009-212157 in which the transformer and the inductance coil are integrated together on a single magnetic core.

Subsequently, the number of turns N of the inductor 22 disposed on the secondary winding side of the equivalent circuit 20 will be discussed. In the transformer device, an output voltage waveform is AC. Under the circumstances, when the induced voltage on the secondary side induced by the applied voltage of the primary side winding is neglected assuming that the induced voltage is small, the magnetic flux φ of the inductor 22, the number of turns N, and an AC voltage (amplitude V) applied to the inductor 22 satisfy the following relational expression on the basis of the Faraday's law. In the expression, ω is an angular frequency of an AC voltage.

$$\begin{matrix}[ Expression 16 ] & \\ N \frac{d φ}{d t} = V sin ω t & ( 16 )\end{matrix}$$

Therefore, a minimum value Nₘᵢₙ of the number of turns required in the inductor 22 can be expressed by the following expression on the basis of a maximum value φₘₐₓ of the magnetic flux permitted in the inductor 22, and the maximum value Vₘₐₓ of the AC voltage.

$$\begin{matrix}[ Expression 17 ] & \\ {N}_{m i n} = \frac{{V}_{m ax}}{ω {φ}_{m ax}} & ( 17 )\end{matrix}$$

On the other hand, considering the transformer device 10 according to the first embodiment, the following expression can be obtained for the voltage waveform of the secondary winding (the specific winding 13) by the application of the Faraday's law.

$$\begin{matrix}[ Expression 18 ] & \\ {N}_{A} \frac{d {φ}_{A}}{d t} + {N}_{B} \frac{d {φ}_{B}}{d t} = V sin ω t & ( 18 )\end{matrix}$$

It is assumed that both of the maximum values of the respective magnetic fluxes permitted in the A section 13a and the B section 13b of the secondary winding (the specific winding 13) are φₘₐₓ, and a maximum value of the amplitude of the voltage is Vₘₐₓ. In this situation, a minimum value N₂_{_{—}}ₘᵢₙ of the number of turns required in the secondary winding (the specific winding 13) is represented as follows.

$$\begin{matrix}[ Expression 19 ] & \\ {N}_{2 \_ m i n} = {( {N}_{A} + {N}_{B} )}_{m i n} = \frac{{V}_{m ax}}{ω {φ}_{m ax}} & ( 19 )\end{matrix}$$

As is apparent from a comparison of Expression 19 with Expression 17, when it is assumed that the respective maximum values φₘₐₓ of the magnetic fluxes are equal to each other in the inductor 22 of the equivalent circuit 20, and the A section 13a and the B section 13b of the secondary winding (the specific winding 13) in the transformer device 10, the minimum value Nₘᵢₙ of the number of turns of the inductor 22 in the equivalent circuit 20 is equal to the minimum value N₂_{_{—}}ₘᵢₙ of the number of turns of the overall secondary winding (the specific winding 13).

Therefore, if the equivalent circuit 20 is replaced with the transformer device 10, the total number of turns of the secondary winding (the specific winding 13) in the transformer device 10 is equal to the number of turns of the inductor in the equivalent circuit 20 to configure the transformer device 10. As a result, the number of turns of the secondary winding does not increase. On the other hand, as described above, the number of turns of the primary winding can be effectively reduced.

[Description of Other Configuration]

In the transformer device 10, the main magnetic path 15 is formed in an outer peripheral portion of the magnetic core 11, and the outer peripheral portion is shaped to surround a rectangular inner space along the contour of the rectangular shape in a plan view.

The A, B sub-magnetic path formation portions, in which the A, B sub-magnetic paths 16, 17 are formed, are formed with gaps, but are shaped to surround the rectangular inner spaces along the rectangular contours in a plan view.

With the above configuration, a leakage magnetic flux can be prevented from being generated from the outer peripheral portion and the A, B sub-magnetic path formation portions, and an electromagnetic interference can be suppressed. Further, the main magnetic path 15 is arranged to surround the outer edges of the A, B sub-magnetic paths 16, 17. With this configuration, a risk that the leakage magnetic flux from the gaps disposed in the A, B sub-magnetic paths 16, 17 electromagnetically interferes with an external circuit of the transformer device 10 can be further suppressed.

In the magnetic core 11, a portion where the normal winding 12 is arranged, and a portion where the specific winding 13 is arranged do not overlap with each other, and the sub-magnetic path is formed by all of the respective sections configuring the specific winding 13. With the above configuration, all of the respective sections of the specific winding 13 function as an inductor, and the necessary inductance can be obtained while suppressing the number of turns of the specific winding 13.

In the magnetic core 11, no gap is formed in the outer peripheral portion where the main magnetic path 15 is formed, but the gaps 11g and 11j are formed in the A, B sub-magnetic path formation portions where the A, B sub-magnetic paths 16, 17 are formed. Accordingly, the outer peripheral portion is lower in the magnetic resistance than the A, B sub-magnetic path formation portions.

For example, the gaps 11g and 11j may be replaced with a material having a low permeability to increase the magnetic resistance of the A, B sub-magnetic path formation portions, which corresponds to an increase in the magnetic resistance of the inductor 22 in the equivalent circuit 20. As a result, a risk that the magnetic saturation is generated by allowing a current to flow into the specific winding 13 can be effectively suppressed.

Providing no gap in the main magnetic path 15 corresponds to an increase in the exciting inductance of the transformer 21 in the equivalent circuit 20. Accordingly, a power factor in transmitting an electric power between the normal winding 12 and the specific winding 13 can increase, and the energy can be efficiently transmitted.

Cross-sectional areas of cross-sections 11e-1 and 11f-1 orthogonal to the A sub-magnetic path 16 in the first projection 11e and the second projection 11f of the magnetic core 11 have sizes corresponding to the magnitude of the magnetic flux forming the A sub-magnetic path 16.

In other words, the above cross-sectional areas have a size capable of sufficiently passing the maximum magnetic flux φₘₐₓ permitted in the A section 13a of the specific winding 13. The cross-sectional areas of cross sections 11h-1 and 11i-1 orthogonal to the A sub-magnetic path 16 and the B sub-magnetic path 17 in the third projection 11h and the fourth projection 11i have sizes corresponding to a total of the magnitude of the magnetic flux forming the A sub-magnetic path 16, and the magnitude of the magnetic flux forming the B sub-magnetic path 17.

In other words, when both of the maximum magnetic flux φₘₐₓ permitted in the A section 13a of the specific winding 13 and the maximum magnetic flux φₘₐₓ permitted in the B section 13b are generated at the same time, the above cross-sectional areas have a size capable of sufficiently passing the magnetic fluxes.

With the above configuration, the magnetic saturation in the A, B sub-magnetic path formation portions can be further effectively suppressed. It is preferable that a circuit including the transformer device 10 is configured in the first terminal 13c of the specific winding 13 in the transformer device 10 so that a potential close to the potential of the normal winding 12 as compared with the second terminal 13d is generated.

Specifically, for example, if an AC voltage applied to the normal winding 12 (the primary winding) is boosted with the use of a booster circuit of an ignition device for an internal combustion engine as the transformer device 10, it is preferable that the first terminal 13c of the specific winding 13 (the secondary winding) is connected to the ground, the second terminal 13d is connected to an ignition plug, and a high voltage is generated in the second terminal 13d.

With the above configuration, insulation between the normal winding 12 (the primary winding) and the specific winding 13 (the secondary winding) can be more surely ensured. Incidentally, the magnetic resistance of the A, B sub-magnetic path formation portions can be regulated according to the sizes of the gaps 11g and 11j and the sizes of the cross-sectional areas.

It is needless to say that the magnetic resistance can be regulated by replacing the gaps 11g and 11j with the material having a low permeability, or arranging such a material in a part of the magnetic core 11. Under the circumstances, it is preferable that the magnetic resistances of the A, B sub-magnetic path formation portions are regulated so that the magnetic flux φ_{A} forming the A sub-magnetic path 16 and the magnetic flux φ_{B} forming the B sub-magnetic path 17 are similar to each other.

As a result, the magnetic saturation is uniformly generated in the sub-magnetic path formation portions, and more excellent DC bias characteristics can be obtained while suppressing an increase in the size of the magnetic core.

### Specific Example

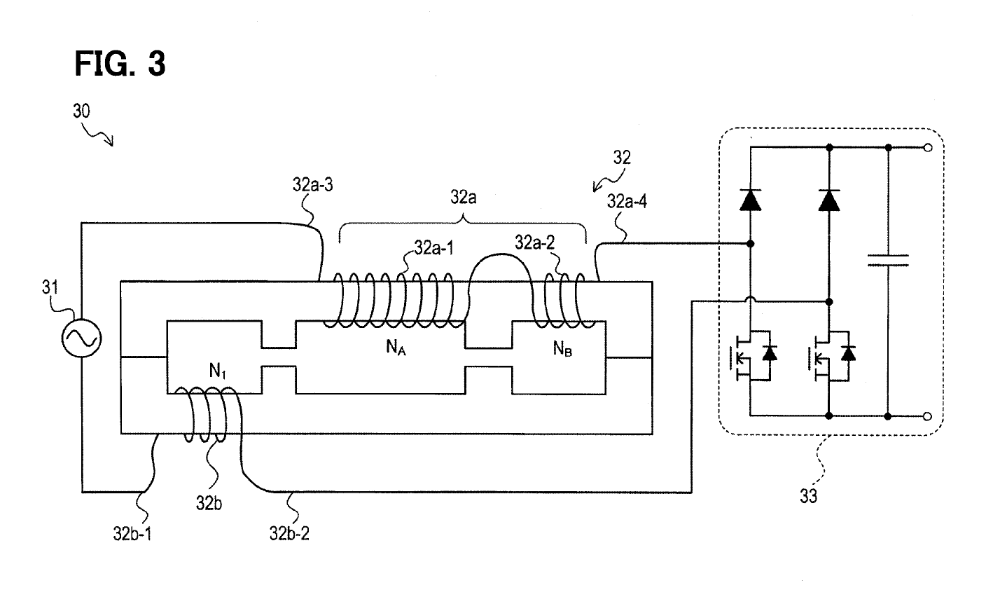

Subsequently, a description will be given of a case in which an AC/DC converter 30 that converts an AC voltage from a commercial power supply 31 into a DC voltage is configured with the use of the transformer device 10 of the first embodiment as a common mode choke coil 32 (see FIG. 3).

The common mode choke coil 32 in the AC/DC converter 30 has the same configuration as the transformer device 10. In the transformer device, a difference between the number of turns N_{A} of an A section 32a-1 and the number of turns N_{B} of a B section 32a-2 in a specific winding 32a matches the number of turns N₁ of a normal winding 32b. Accordingly, in the transformer device, the number of turns of the primary winding is identical with the number of turns of the secondary winding in functioning as the transformer, and the transformer device can be used as the common mode choke coil 32.

When the transformer device is used as the common mode choke coil 32, it can be arbitrarily determined how two windings configuring the common mode choke correspond to the secondary winding and the normal winding.

In the common mode choke coil 32, a first terminal 32b-1 of the normal winding 32b and a first terminal 32a-3 of the specific winding 32a are connected to the commercial power supply 31, and noise of a common mode is removed from an AC voltage applied from the commercial power supply 31.

In the common mode choke coil 32, a second terminal 32b-2 of the normal winding 32b and a second terminal 32a-4 of the specific winding 32a are connected to a bridgeless PFC converter 33, and the AC voltage from which the noise of the common mode has been removed is input to the bridgeless PFC converter 33.

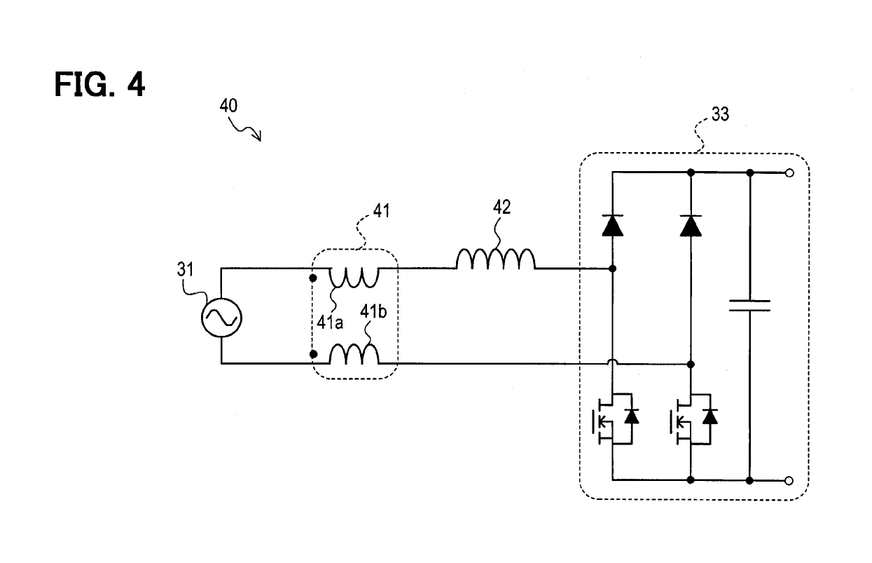

The bridgeless PFC converter 33 converts the AC voltage from the common mode choke coil 32 into a DC voltage. FIG. 4 illustrates an equivalent circuit 40 of the AC/DC converter 30. In the equivalent circuit 40, an inductor 42 is connected to one winding 41a of a common mode choke coil 41.

### Second Embodiment

### Description of Main Configuration

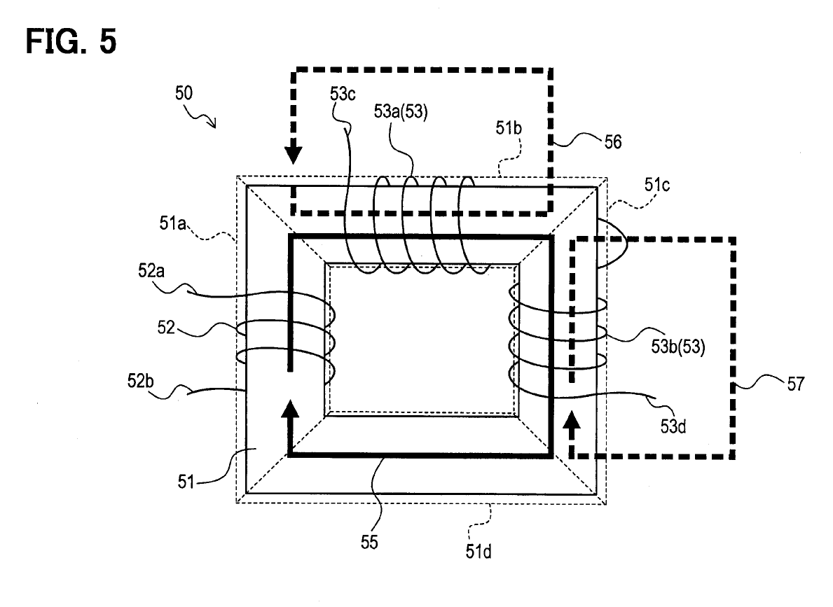

Subsequently, a transformer device 50 according to a second embodiment will be described (see FIG. 5). The transformer device 50 is also used in, for example, an ignition device for an internal combustion engine, a booster circuit in a liquid crystal monitor, a converter, an inverter, or a filter.

A magnetic core 51 of the transformer device 50 is formed in a flat rectangular shape which is square in a main surface, and a rectangular hole that penetrates the magnetic core 51 is formed in the center of the main surface. In other words, the magnetic core 51 is configured to surround an inner space having a square shape in a plan view along a contour of the square shape.

In this example, four portions forming sides of the main surface of the magnetic core 51 are called “first to fourth outer peripheral portions 51a to 51d”. The first outer peripheral portion 51a which is one of the outer peripheral portions is equipped with a normal winding 52. The second outer peripheral portion 51b adjacent to the first outer peripheral portion 51a, and the third outer peripheral portion 51c facing the first outer peripheral portion 51a are equipped with a specific winding 53.

The specific winding 53 includes an A section 53a disposed in the second outer peripheral portion 51b, and a B section 53b disposed in the third outer peripheral portion 51c. In the A section 53a and the B section 53b, a direction of winding the conductive wire is different from each other.

Specifically, for example, it is assumed that a main magnetic path 55 is formed in the magnetic core 51 from the first outer peripheral portion 51a toward the second outer peripheral portion 51b. In this case, the A section 53a is formed by winding the conductive wire clockwise toward a direction of the main magnetic path 55, and the B section 53b is formed by winding the conductive wire counterclockwise toward the direction. It is needless to say that the respective winding directions of the conductive wire in the A section 53a and in the B section 53b may be opposite to the directions described above.

The number of turns of the conductive wire in the A section 53a is larger than the number of turns of the conductive wire in the B section 53b. In this example, when a voltage is applied to the normal winding 52, as in the first embodiment, the main magnetic path 55 interlinked with all of the sections in the specific winding 53 is formed by the normal winding 52. The main magnetic path 55 is formed along the magnetic core 51. An orientation of the main magnetic path 55 in FIG. 5 is indicated as an orientation of the magnetic flux that is generated when a current from a first terminal 52a toward a second terminal 52b is supplied to the normal winding 52.

When a voltage is applied to the specific winding 53, as in the first embodiment, magnetic fluxes are formed in an A sub-magnetic path 56 and a B sub-magnetic path 57 by the A section 53a and the B section 53b, respectively, and the A sub-magnetic path 56 and the B sub-magnetic path 57 are not interlinked with the normal winding 52

In the second embodiment, the A sub-magnetic path 56 is formed in the second outer peripheral portion 51b and a space outside of the second outer peripheral portion 51b, and the sub-magnetic path 57 is formed in the third outer peripheral portion 51c and a space outside of the third outer peripheral portion 51c.

The orientations of the A sub-magnetic path 56 and the B sub-magnetic path 57 in FIG. 5 are indicated as the orientation of the magnetic flux that is generated when the current flowing from a first terminal 53c toward a second terminal 53d is supplied to the specific winding 53.

In the transformer device 50 according to the second embodiment, in the A, B sections 53a and 53b of the specific winding 53, the winding direction of the winding is opposite to each other, and the number of turns is different from each other. The A, B sub-magnetic paths 56, 57 that pass through the external of the magnetic core 51 are formed by the respective sections.

Accordingly, the same equivalent circuit as the first embodiment is obtained in the transformer device 50, and in the equivalent circuit, the number of turns of the secondary winding in the transformer is smaller than the total number of turns of the specific winding 53.

Therefore, if the turn ratio of the primary winding and the secondary winding is the same, the number of turns of the primary winding can be reduced as compared with the transformer device in JP-A-2009-212157 in which the transformer and the inductance coil are integrated together on a single magnetic core.

As in the first embodiment, the total number of turns of the specific winding 53 in the transformer device 50 is equal to the number of turns of the inductor in the equivalent circuit 20, and the number of turns of the secondary winding does not increase by the configuration of the transformer device 50.

[Description of Other Configuration]

In the magnetic core 51 of the transformer device 50, a portion where the normal winding 52 is arranged, and a portion where the specific winding 53 is arranged do not overlap with each other, and the sub-magnetic path is formed by each of the A, B sections 53a and 53b configuring the specific winding 53.

With the above configuration, all of the respective sections of the specific winding 53 function as an inductor, and the necessary inductance can be obtained while suppressing the number of turns of the specific winding 53. In the second embodiment, the main magnetic path 55 is formed within the magnetic core 51, but the A, B sub-magnetic paths 56, 57 pass through the outside of the magnetic core 51. Accordingly, a portion in which the main magnetic path 55 is formed is lower in magnetic resistance than portions in which the A, B sub-magnetic paths 56, 57 are formed.

Therefore, as in the first embodiment, a power factor in transmitting an electric power between the normal winding 52 and the specific winding 53 can increase, and an energy can be efficiently transmitted. It is preferable that the transformer device 50 is configured so that a potential closer to the potential of the normal winding 52 than the second terminal 53d is generated in the first terminal 53c of the specific winding 53.

Specifically, for example, if a voltage applied to the normal winding 52 (the primary winding) is boosted with the use of the transformer device 50 for a booster circuit of an ignition device for an internal combustion engine, it is preferable that the first terminal 53c of the specific winding 53 (the secondary winding) is connected to the ground side, the second terminal 53d is connected to an ignition plug, and a high voltage is generated in the second terminal 53d.

With the above configuration, insulation between the normal winding 52 (the primary winding) and the specific winding 53 (the secondary winding) can be more surely ensured.

### Third Embodiment

### Description of Main Configuration

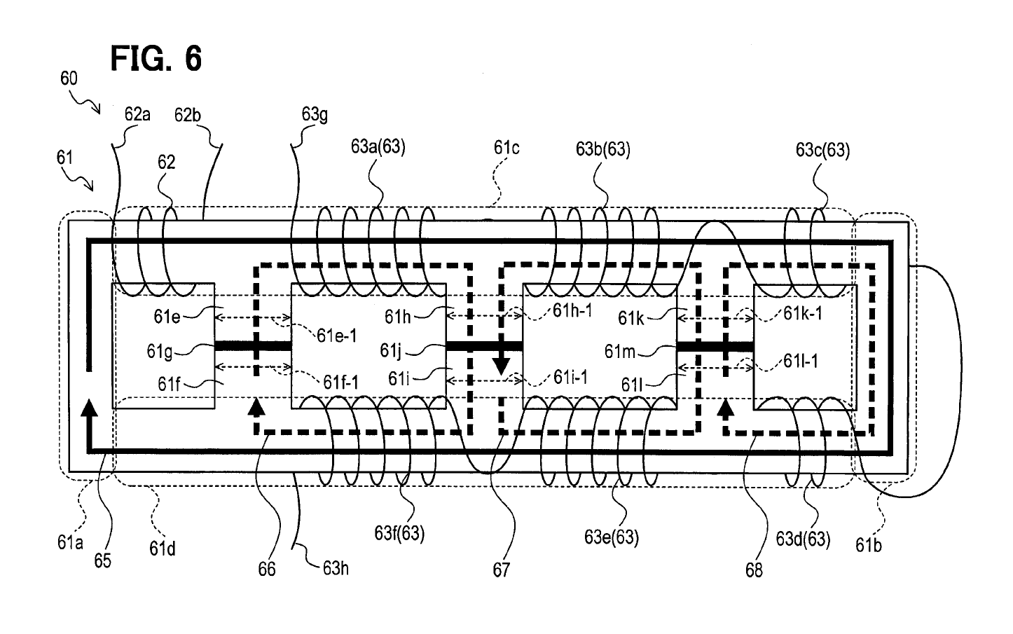

Subsequently, a transformer device 60 according to a third embodiment will be described (see FIG. 6). The transformer device 60 is also used in, for example, an ignition device for an internal combustion engine, a booster circuit in a liquid crystal monitor, a converter, an inverter, or a filter.

A magnetic core 61 of the transformer device 60 is formed in a substantially rectangular shape, and a hole that penetrates the magnetic core 61 is formed in the center of the magnetic core 61. In other words, the magnetic core 61 is configured to surround an inner space having a rectangular shape in a plan view along a contour of the rectangular shape.

Hereinafter, respective portions forming short sides in an outer peripheral portion of the magnetic core 61 are called “left short portion 61a” and “right short portion 61b”, and respective portions forming long sides in the outer peripheral portion are called “upper long portion 61c” and “lower long portion 61d”.

A first projection 61e and a second projection 61f, a third projection 61h and a fourth projection 61i, and a fifth projection 61k and a sixth projection 61l, which project inward, are disposed on inner peripheral sides of the upper long portion 61c and the lower long portion 61d.

The first projection 61e and the second projection 61f are arranged at a predetermined distance from the left short portion 61a, and the fifth projection 61k and the sixth projection 61l are arranged at a distance set separately from the right short portion 61b.

The third projection 61h and the fourth projection 61i are arranged in the middle of positions of the first and second projections 61e, 61f, and positions of the fifth and sixth projections 61k, 61l. Tip portions of the first projection 61e and the second projection 61f, tip portions of the third projection 61h and the fourth projection 61i, and tip portions of the fifth projection 61k and the sixth projection 61l are each arranged to face each other in the inner space, and gaps 61g, 61j, and 61m are formed by the tip portions.

A normal winding 62 is disposed at a position of the upper long portion 61c, which is sandwiched between the left short portion 61a and the first projection 61e. A specific winding 63 is disposed at each of a position of the upper long portion 61c, which is sandwiched between the first projection 61e and the right short portion 61b, and at a position of the lower long portion 61d, which is sandwiched between the second projection 61f and the right short portion 61b.

Further, the specific winding 63 includes an A1 section 63a arranged between the first projection 61e and the third projection 61h, a B1 section 63b arranged between the third projection 61h and the fifth projection 61k, and an A2 section 63c arranged between the fifth projection 61k and the right short portion 61b.

The specific winding 63 additionally includes an A3 section 63d arranged between the right short portion 61b and the sixth projection 61l, a B2 section 63e arranged between the sixth projection 61l and the fourth projection 61i, and an A4 section 63f arranged between the fourth projection 61i and the second projection 61f.

The direction of winding the conductive wire is different between the A1 to A4 sections 63a, 63c, 63d, and 63f (hereinafter also called “A section”), and the B1, B2 sections 63b and 63e (hereinafter also called “B section”).

Specifically, for example, the orientation of a main magnetic path 65 is set to an orientation of the outer peripheral portion of a magnetic core 61 from the left short portion 61a toward the right short portion 61b. In this case, the A section is formed by winding the conductive wire clockwise toward a direction of the main magnetic path 65, and the B section is formed by winding the conductive wire counterclockwise toward the direction. It is needless to say that the respective winding directions of the conductive wire in the A section and in the B section may be opposite to the directions described above.

The total number of turns of the conductive wire in the A section is larger than the total number of turns of the conductive wire in the B section. In this example, when a voltage is applied to the normal winding 62, as in the first embodiment, the magnetic flux is formed on the main magnetic path 65 interlinked with all of the sections in the specific winding 63 by the normal winding 62. The main magnetic path 65 is formed along the outer peripheral portion (the upper long portion 61c, the right short portion 61b, the lower long portion 61d, the left short portion 61a) of the magnetic core 61. An orientation of the main magnetic path 65 in FIG. 6 is indicated as an orientation of the magnetic flux that is generated when a current flowing from a first terminal 62a toward a second terminal 62b is supplied to the normal winding 62.

When a voltage is applied to the specific winding 63, as in the first embodiment, the respective magnetic fluxes are generated by the A1 to A4, B1, and B2 sections. A portion of the magnetic path of the magnetic flux generated by the sections which is not interlinked with the normal winding 62 is called “a sub-magnetic path”.

In the third embodiment, an A1 sub-magnetic path 66 by the A section 63a and the A4 section 63f, a B sub-magnetic path 67 by the B1 section 63b and the B2 section 63e, and an A2 sub-magnetic path 68 by the A2 section 63c and the A3 section 63d are formed.

The A1 sub-magnetic path 66 is formed in a section of the upper long portion 61c of the magnetic core 61 from the first projection 61e to the third projection 61h, the third projection 61h, the fourth projection 61i, a section of the lower long portion 61d from the second projection 61f to the fourth projection 61i, the first projection 61e, and the second projection 61f. Hereinafter, a portion in which the A1 sub-magnetic path 66 is formed is called “A1 sub-magnetic path formation portion”.

The B sub-magnetic path 67 is formed in a section of the upper long portion 61c of the magnetic core 61 from the third projection 61h to the fifth projection 61k, the fifth projection 61k, the sixth projection 61l, a section of the lower long portion 61d from the fourth projection 61i to the sixth projection 61l, the third projection 61h, and the fourth projection 61i. Hereinafter, a portion in which the B sub-magnetic path 67 is formed is called “sub-magnetic path formation portion B”.

The A2 sub-magnetic path 68 is formed in a section of the upper long portion 61c of the magnetic core 61 from the fifth projection 61k to the right short portion 61b, the right short portion 61b, a section of the lower long portion 61d from the sixth projection 61l to the right short portion 61b, the fifth projection 61k, and the sixth projection 61l. Hereinafter, a portion in which the A2 sub-magnetic path 68 is formed is also called “A2 sub-magnetic path formation portion”.

The orientations of the A1, A2, B sub-magnetic paths 66 to 68 in FIG. 6 are indicated as the orientation of the magnetic flux that is generated when the current flowing from a first terminal 63g toward a second terminal 63h is supplied to the specific winding 63.

In the transformer device 60 according to the third embodiment, in the A, B sections of the specific winding 63, the winding direction of the winding is opposite to each other, and the number of turns is different from each other. The A1, A2, B sub-magnetic paths 66 to 68 are formed within the magnetic core 61 from the respective sections.

Accordingly, the same equivalent circuit as that in the first embodiment is also obtained in the transformer device 60, and in the equivalent circuit, the number of turns of the secondary winding in the transformer is smaller than the total number of turns of the specific winding 63.

Therefore, if the turn ratio of the primary winding and the secondary winding is the same, the number of turns of the primary winding can be reduced as compared with the transformer device of JP-A-2009-212157 in which the transformer and the inductance coil are integrated together on a single magnetic core.

As in the first embodiment, the total number of turns of the specific winding 63 in the transformer device 60 is equal to the number of turns of the inductor in the equivalent circuit, and the number of turns of the specific winding 63 does not increase by the configuration of the transformer device 60.

[Description of Other Configuration]

In the transformer device 60, the main magnetic path 65 is formed in an outer peripheral portion of the magnetic core 61, and the outer peripheral portion is shaped to surround a rectangular inner space along the contour of the rectangular shape in a plan view.

The A1, A2, and B sub-magnetic path formation portions, in which the A1, A2, and B sub-magnetic paths 66 to 68 are formed, are formed with gaps, but are shaped to surround the rectangular inner spaces along the rectangular contours.

With the above configuration, a leakage magnetic flux can be prevented from being generated from the outer peripheral portion and the A1, A2, and B sub-magnetic path formation portions, and an electromagnetic interference can be suppressed. Further, the main magnetic path 65 is arranged to surround the outer edges of the A1, A2, and B sub-magnetic paths 66 to 68. With this configuration, a risk that the leakage magnetic flux from the gaps disposed in the A1, A2, and B sub-magnetic paths 66 to 68 electromagnetically interferes with an external circuit of the transformer device 60 can be further suppressed.

In the magnetic core 61, a portion where the normal winding 62 is arranged, and a portion where the specific winding 63 is arranged do not overlap with each other, and the sub-magnetic path is formed by all of the respective sections configuring the specific winding 63. With the above configuration, the respective sections of the specific winding 63 function as an inductor, and the necessary inductance can be obtained while suppressing the number of turns of the specific winding 63.

In the magnetic core 61, no gap is formed in the outer peripheral portion where the main magnetic path 65 is formed, but the gaps 61g, 61i, and 61m are formed in the A1, A2, and B sub-magnetic path formation portions where the A1, A2, and B sub-magnetic paths 66 to 68 are formed. Accordingly, the outer peripheral portion is lower in the magnetic resistance than the A1, A2, B sub-magnetic paths 66 to 68.

For example, the gaps 61g, 61j, and 61m may be replaced with a material having a low permeability to increase the magnetic resistance of the A1, A2, and B sub-magnetic paths 66 to 68. As a result, as in the first embodiment, the magnetic saturation generated by the current flowing in the specific winding 63 can be suppressed.

Providing no gap in the main magnetic path 65 corresponds to an increase in the exciting inductance of the transformer in the equivalent circuit. As a result, a power factor in transmitting an electric power between the normal winding 62 and the specific winding 63 can increase, and an energy can be efficiently transmitted.

Cross-sectional areas of cross-sections 61e-1 and 61f-1 orthogonal to the A1 sub-magnetic path 66 in the first projection 61e and the second projection 61f of the magnetic core 61 have sizes corresponding to the magnitude of the magnetic flux forming the A1 sub-magnetic path 66.

In other words, when both of the maximum magnetic fluxes permitted in the A1, A4 sections 63a, 63f of the specific winding 63 are generated at the same time, the above cross-sectional areas have a size capable of sufficiently passing the magnetic fluxes.

The cross-sectional areas of cross sections 61h-1 and 61i-1 orthogonal to the A1 sub-magnetic path 66 and the B sub-magnetic path 67 in the third projection 61h and the fourth projection 61i have sizes corresponding to a total of the magnitude of the magnetic flux forming the A1 sub-magnetic path 66, and the magnitude of the magnetic flux forming the B sub-magnetic path 67.

In other words, when both of the respective maximum magnetic fluxes permitted in the A1, A4 sections 63a, 63f and the B1, B2 sections 63b, 63e of the specific winding 63 are generated at the same time, the above cross-sectional areas have a size capable of sufficiently passing the magnetic fluxes.

The cross-sectional areas of cross sections 61k-1 and 61l-1 orthogonal to the B sub-magnetic path 67 and the A2 sub-magnetic path 68 in the fifth projection 61k and the sixth projection 61l have sizes corresponding to a total of the magnitude of the magnetic flux forming the B sub-magnetic path 67, and the magnitude of the magnetic flux forming the A2 sub-magnetic path 68.

In other words, when both of the maximum magnetic fluxes permitted in the B1, B2 sections 63b, 63e, and the A2, A3 sections 63c, 63d of the specific winding 63 are generated at the same time, the above cross-sectional areas have a size capable of sufficiently passing the magnetic fluxes.

With the above configuration, the magnetic saturation in the A1, A2, and B sub-magnetic path formation portions can be effectively suppressed. It is preferable that a potential closer to the potential of the normal winding 62 than that of the second terminal 63h is generated in the first terminal 63g of the specific winding 63 in the transformer device 60.

Specifically, for example, if a voltage applied to the normal winding 62 (the primary winding) is boosted with the use of the transformer device 60 for a booster circuit of an ignition device for an internal combustion engine, it is preferable that the first terminal 63g of the specific winding 63 (the secondary winding) is connected to the ground side, the second terminal 63h is connected to an ignition plug, and a high voltage is generated in the second terminal 63h.

With the above configuration, insulation between the normal winding 62 (the primary winding) and the specific winding 63 (the secondary winding) can be more surely ensured. The magnetic resistance of the A1, A2, and B sub-magnetic path formation portions can be regulated according to the sizes of the gaps 61g, 61j, and 61m and the sizes of the cross-sectional areas.

It is needless to say that the magnetic resistance can be regulated by replacing the gaps 61g, 61j, and 61m with the material having a low permeability, or arranging such a material in a part of the magnetic core 61.

Under the circumstances, the magnetic resistances of the A1, A2, and B sub-magnetic path formation portions may be regulated so that the magnetic flux forming the A1 sub-magnetic path 66, the magnetic flux forming the B sub-magnetic path 67, and the magnetic flux forming the A2 sub-magnetic path 68 are similar to each other.

As a result, the magnetic saturation is uniformly generated in the sub-magnetic path formation portions, and more excellent DC bias characteristics can be obtained while suppressing an increase in the size of the magnetic core.

### Specific Example

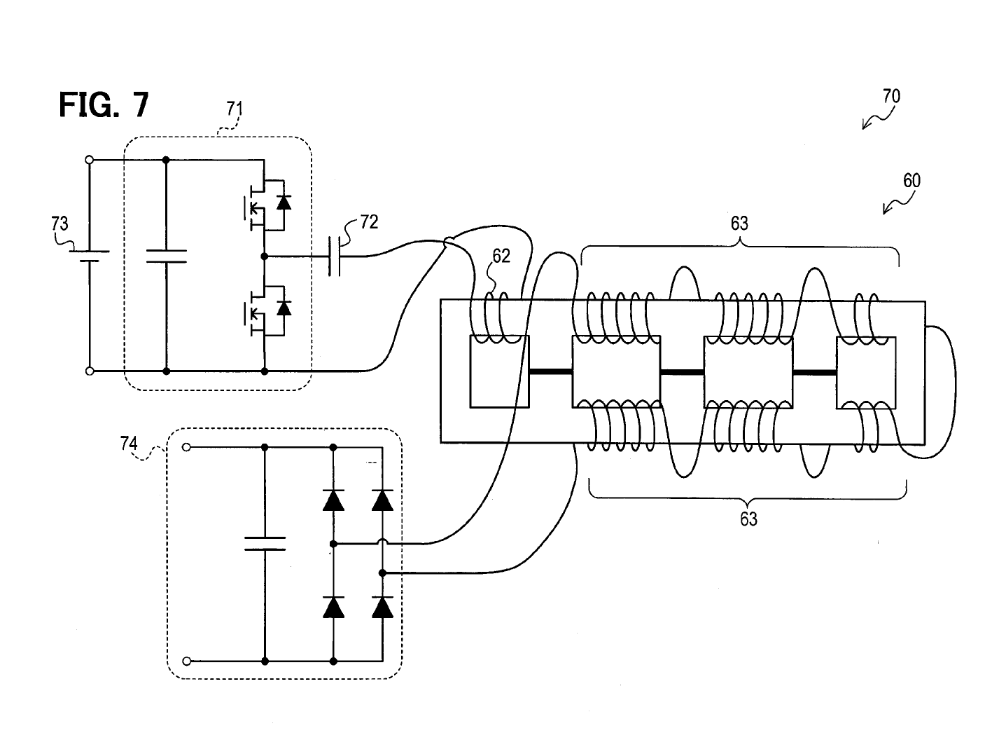

Subsequently, a description will be given of a specific example in which the transformer device 60 according to the third embodiment is applied to a DC/DC converter 70 (see FIG. 7).

In the DC/DC converter 70, the normal winding 62 is used as the primary winding, and the specific winding 63 is used as the secondary winding. The normal winding 62 (the primary winding) is connected to a converter 71 that converts a DC voltage from a DC power supply 73 into an AC voltage, and a capacitor 72 is disposed between one terminal of the normal winding 62 and the converter 71.

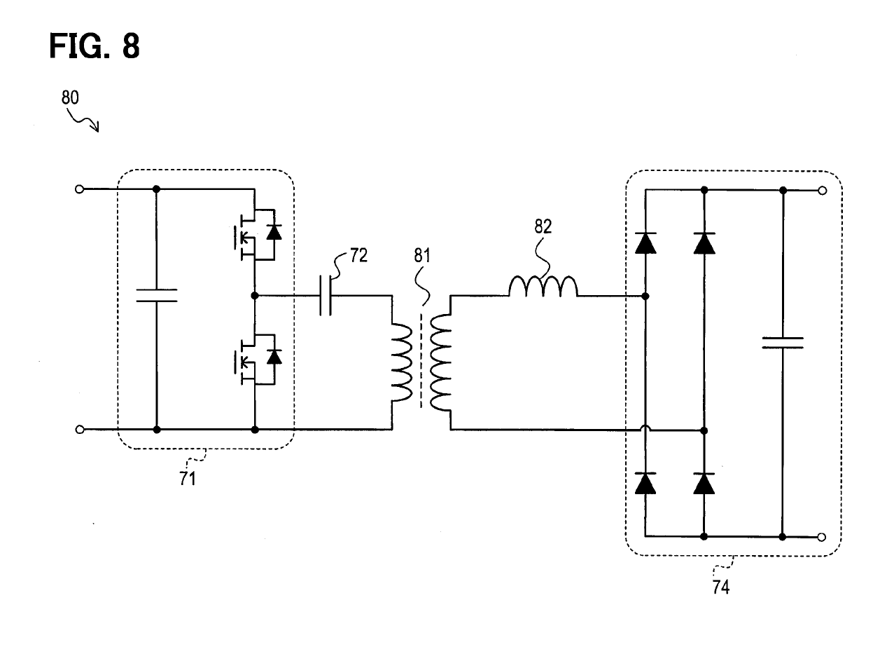

The specific winding 63 (the secondary winding) is connected with a rectifier circuit 74. In an equivalent circuit 80 of the DC/DC converter 70, an inductor 82 is present on a secondary winding side of a transformer 81, and an AC voltage of a sine wave is generated due to resonance generated between the inductor 82 and a capacitor 72 on the primary winding side (see FIG. 8).

The normal winding 62 may be used as the secondary winding, and the specific winding 63 may be used as the primary winding to configure the same DC/DC converter.

### Fourth Embodiment

### Description of Main Configuration

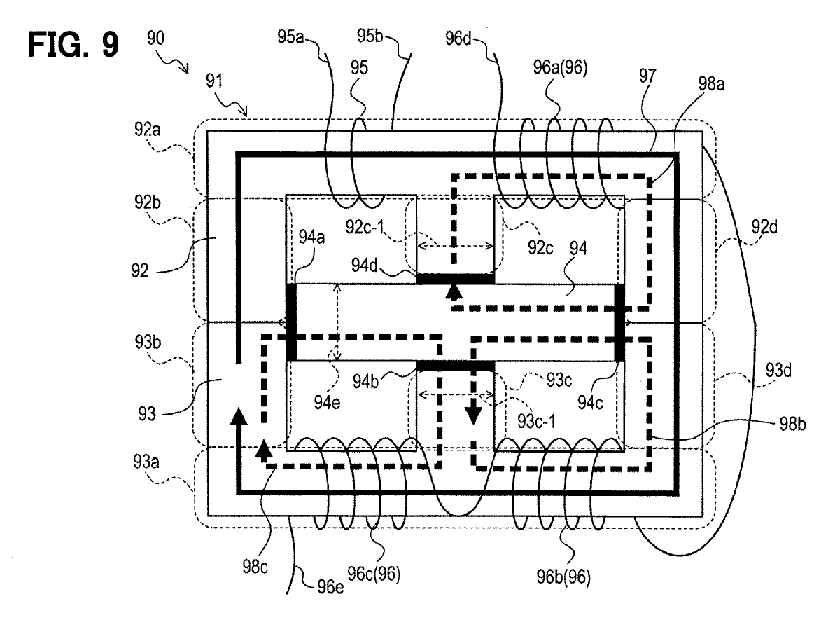

Subsequently, a transformer device 90 according to a fourth embodiment will be described (see FIG. 9). The transformer device 90 is also used in, for example, an ignition device for an internal combustion engine, a booster circuit in a liquid crystal monitor, a converter, an inverter, or a filter.

A magnetic core 91 of the transformer device 90 is integrated with a first base portion 92 and a second base portion 93 which are configured into an E-shape, and a rod-shaped third base portion 94. The first base portion 92 includes a rod portion 92a, a first projection 92b and a third projection 92d projected from both ends of the rod portion 92a, and a second projection 92c projected from a center of the rod portion 92a.

The first to third projections 92b to 92c project in a direction orthogonal to a longitudinal direction of the rod portion 92a. The first and third projections 92b and 92d are identical in length with each other, and a length of the second projection 92c is shorter than that of the first and third projections 92b and 92d.

The second base portion 93 is identical in shape with the first base portion 92, and has first to third projections 93b to 93d of the same configuration as that of the first base portion 92. The third base portion 94 is arranged in a gap generated between the first base portion 92 and the second base portion 93 when tops of the first to third projections 92b to 92d of the first base portion 92 are brought into contact with tops of the first to third projections 93b to 93d of the second base portion 93.

In this situation, gaps 94a and 94c are formed between both ends of the third base portion 94, and the first projection 92b of the first base portion 92 and the first projection 93b of the second base portion 93, and the third projection 92d of the first base portion 92 and the third projection 93d of the second base portion 93, respectively.

Gaps 94d and 94b are formed between a center portion of the third base portion 94, and the second projection 92c of the first base portion 92 and the second projection 93c of the second base portion 93, respectively. A normal winding 95 is disposed over the rod portion 92a of the first base portion 92 between the first projection 92b and the second projection 92c.

Respective specific windings 96 are disposed over the rod portion 92a of the first base portion 92 between the second projection 92c and the third projection 92d, over a rod portion 93a of the second base portion 93 between the second projection 93c and the third projection 93d, and between the first projection 93b and the second projection 93c.

Further, the specific windings 96 include an A1 section 96a arranged between the second projection 92c and the third projection 92d of the first base portion 92. The specific windings 96 include a B section 96b arranged between the second projection 93c and the third projection 93d of the second base portion 93, and an A2 section 96c arranged between the first projection 93b and the second projection 93c of the second base portion 93.

The direction of winding the conductive wire is different between the A1, A2 sections 96a, 96c (hereinafter also called “A section”) and the B section 96b. Specifically, for example, in the magnetic core 91, an orientation of a main magnetic path 97 is set to an orientation from the first projection 92b of the first base portion 92 toward the second projection 92c. In this case, the A section is formed by winding the conductive wire clockwise toward a direction of the main magnetic path 97, and the B section 96b is formed by winding the conductive wire counterclockwise toward the direction. It is needless to say that the respective winding directions of the conductive wire in the A section and in the B section 96b may be opposite to the directions described above.

The total number of turns of the conductive wire in the A section is larger than the number of turns of the conductive wire in the B section 96b. In this situation, when a voltage is applied to the normal winding 95, as in the first embodiment, a magnetic flux that passes through the main magnetic path 97 is formed. The main magnetic path 97 is formed along the outer peripheral portion of magnetic core 91. An orientation of the main magnetic path 97 in FIG. 9 is indicated as an orientation of the magnetic flux that is generated when a current flowing from a first terminal 95a toward a second terminal 95b is supplied to the normal winding 95.

When a voltage is applied to the specific winding 96, a magnetic flux is generated in each of the A1, A2, B sections 96a to 96c. A portion of the magnetic path of the magnetic flux generated by the sections which is not interlinked with the normal winding 95 is called “a sub-magnetic path”.

In the fourth embodiment, an A1 sub-magnetic path 98a by the A1 section 96a, a B sub-magnetic path 98b by the B section 96b, and an A2 sub-magnetic path 98c by the A2 section 96c are formed. The A1 sub-magnetic path 98a is formed in a section of the rod portion 92a of the first base portion 92 from the second projection 92c to the third projection 92d, the second projection 92c, the third projection 92d, a section of the third base portion 94 from a portion that comes into contact with the second projection 92c to a portion that comes into contact with the third projection 92d, and a tip portion of the third projection 93d of the second base portion 93. Hereinafter, a portion in which the A1 sub-magnetic path 98a is formed is called “A1 sub-magnetic path formation portion”.

The B sub-magnetic path 98b is formed in a section of the rod portion 93a of the second base portion 93 from the second projection 93c to the third projection 93d, the second projection 93c, the third projection 93d, a section of the third base portion 94 from a portion that comes into contact with the second projection 93c to a portion that comes into contact with the third projection 93d, and a tip portion of the third projection 92d of the first base portion 92. Hereinafter, a portion in which the B sub-magnetic path 98b is formed is called “sub-magnetic path formation portion B”.

The A2 sub-magnetic path 98c is formed in a section of the rod portion 93a of the second base portion 93 from the second projection 93c to the first projection 93b, the second projection 93c, the first projection 93b, a section of the third base portion 94 from a portion that comes into contact with the second projection 93c to a portion that comes into contact with the first projection 93b, and a tip portion of the first projection 92b of the first base portion 92. Hereinafter, a portion in which the A2 sub-magnetic path 98c is formed is called “A2 sub-magnetic path formation portion”.

The orientations of the A1, A2, B sub-magnetic paths 98a to 98c in FIG. 9 are indicated as the orientation of the magnetic flux that is generated when the current flowing from a first terminal 96d toward a second terminal 96e is supplied to the specific winding 96.

In the transformer device 90 according to the fourth embodiment, in the A, B sections of the specific winding 96, the winding direction of the winding is opposite to each other, and the number of turns is different from each other. The A1, A2, B sub-magnetic paths 98a to 98c are formed within the magnetic core 91 from the respective sections.

Accordingly, the same equivalent circuit as that in the first embodiment is also obtained in the transformer device 90, and in the equivalent circuit, the number of turns of the secondary winding of the transformer is smaller than the total number of turns of the specific winding 96.

Therefore, if the turn ratio of the primary winding and the secondary winding is the same, the number of turns of the primary winding can be reduced as compared with the transformer device of JP-A-2009-212157 in which the transformer and the inductance coil are integrated together on a single magnetic core.

As in the first embodiment, the total number of turns of the specific winding 96 in the transformer device 90 is equal to the number of turns of the inductor in the equivalent circuit, and the number of turns of the specific winding 96 does not increase by the configuration of the transformer device 90.

[Description of Other Configuration]

In the transformer device 90, the main magnetic path 97 is formed in an outer peripheral portion of the magnetic core 91, and the outer peripheral portion is shaped to surround a rectangular inner space along the contour of the rectangular shape in a plan view.

The A1, A2, and B sub-magnetic path formation portions, in which the A1, A2, and B sub-magnetic paths 98a to 98c are formed, are formed with gaps, but are shaped to surround the rectangular inner spaces along the rectangular contours in a plan view.

With the above configuration, a leakage magnetic flux can be prevented from being generated from the outer peripheral portion, and the A1, A2, and B sub-magnetic path formation portions, and an electromagnetic interference can be suppressed. Further, the main magnetic path 97 is arranged to surround the outer edges of the A1, A2, and B sub-magnetic paths 98a to 98c. With this configuration, a risk that the leakage magnetic flux from the gaps disposed in the A1, A2, and B sub-magnetic paths 98a to 98c electromagnetically interferes with an external circuit of the transformer device 90 can be further suppressed.

In the magnetic core 91, a portion where the normal winding 95 is arranged, and a portion where the specific winding 96 is arranged do not overlap with each other, and the sub-magnetic path is formed by the respective sections configuring the specific winding 96. With the above configuration, all of the respective sections of the specific winding 96 function as an inductor, and the necessary inductance can be obtained while suppressing the number of turns of the specific winding 96.

In the magnetic core 91, no gap is formed in the outer peripheral portion where the main magnetic path 97 is formed, but the gaps 94a to 94d are formed in the A1, A2, and B sub-magnetic path formation portions where the A1, A2, B sub-magnetic paths 98a to 98c are formed. Accordingly, the outer peripheral portion is lower in the magnetic resistance than the A1, A2, and B sub-magnetic path formation portions.

For example, the gaps 94a to 94d may be replaced with a material having a low permeability to increase the magnetic resistance of the A1, A2, and B sub-magnetic paths 98a to 98c. As a result, as in the first embodiment, the magnetic saturation generated by the current flowing in the specific winding 96 can be suppressed.

Providing no gap in the main magnetic path 97 corresponds to an increase in the exciting inductance of the transformer in the equivalent circuit. As a result, a power factor in transmitting an electric power between the normal winding 95 and the specific winding 96 can increase, and an energy can be efficiently transmitted.

A cross-sectional area of a cross-section 92c-1 orthogonal to the A1 sub-magnetic path 98a in the second projection 92c of the first base portion 92 of the magnetic core 91 has a size corresponding to the magnitude of the magnetic flux forming the A1 sub-magnetic path 98a.

In other words, the above cross-sectional areas have a size capable of sufficiently passing the maximum magnetic flux permitted in the A1 section 96a of the specific winding 96. A cross-sectional area of a cross-section 94e (in other words, cross-section 94e orthogonal to the A2 sub-magnetic path 98c) orthogonal to the A1 sub-magnetic path 98a and the B sub-magnetic path 98b in the third base portion 94 has a size corresponding to a larger one of a sum of the magnitude of the magnetic flux forming the A1 sub-magnetic path 98a, and the magnitude of the magnetic flux forming the B sub-magnetic path 98b, and the magnitude of the magnetic flux forming the A2 sub-magnetic path 98c.

In other words, when the maximum magnetic flux permitted in the A1 section 96a of the specific winding 96, the maximum magnetic flux permitted in the B section 96b, and the maximum magnetic flux permitted in the A2 section 96c are generated at the same time, the above cross-sectional area has a size capable of sufficiently passing the magnetic fluxes.

With the above configuration, the magnetic saturation in the A1, A2, and B sub-magnetic path formation portions can be effectively suppressed. It is preferable that the transformer device 90 is configured so that a potential closer to the potential of the normal winding 95 than the second terminal 96e is generated in the first terminal 96d of the specific winding 96.

Specifically, for example, if a voltage applied to the normal winding 95 (the primary winding) is boosted with the use of the transformer device 90 for a booster circuit of an ignition device for an internal combustion engine, it is preferable that the first terminal 96d of the specific winding 96 (the secondary winding) is connected to the ground side, the second terminal 96e is connected to an ignition plug, and a high voltage is generated in the second terminal 96e.

With the above configuration, insulation between the normal winding 95 (the primary winding) and the specific winding 96 (the secondary winding) can be more surely ensured. The magnetic resistance of the A1, A2, and B sub-magnetic path formation portions can be regulated according to the sizes of the gaps 94a to 94d and the sizes of the cross-sectional areas.

It is needless to say that the magnetic resistance can be regulated by replacing the gaps 94a to 94d with the material having a low permeability, or arranging such a material in a part of the magnetic core 91. Under the circumstances, the magnetic resistances of the A1, A2, and B sub-magnetic path formation portions may be regulated so that the magnetic flux forming the A1 sub-magnetic path 98a, the magnetic flux forming the B sub-magnetic path 98b, and the magnetic flux forming the A2 sub-magnetic path 98c are similar to each other.

As a result, the magnetic saturation is uniformly generated in the sub-magnetic path formation portions, and more excellent DC bias characteristics can be obtained while suppressing an increase in the size of the magnetic core.

### Specific Example

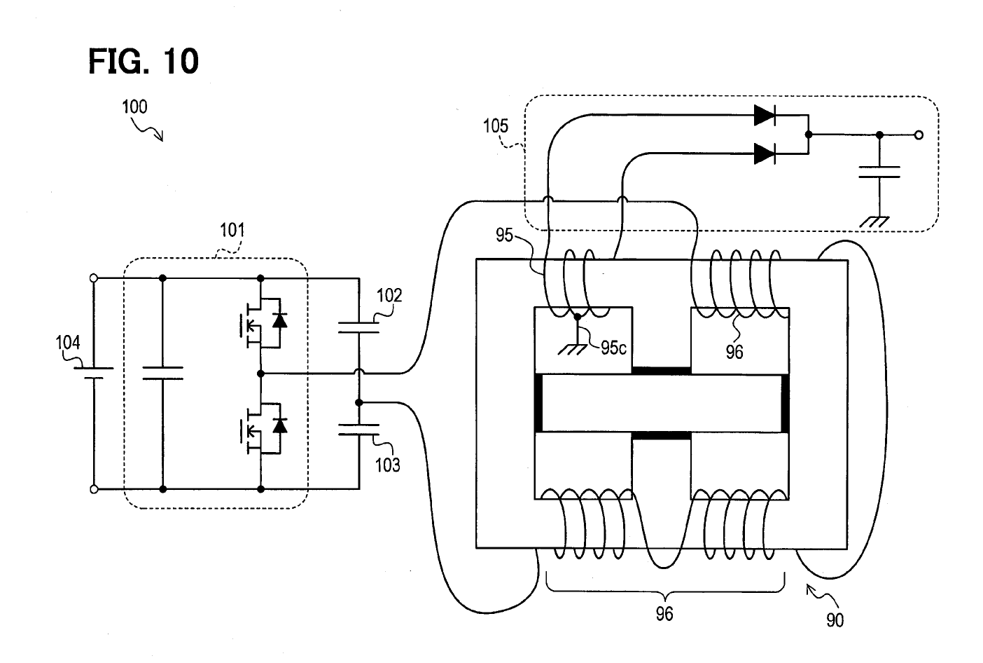

Subsequently, a description will be given of a specific example in which the transformer device 90 according to the fourth embodiment is applied to a DC/DC converter 100 (see FIG. 10).

In the DC/DC converter 100, the normal winding 95 is used as the secondary winding, and the specific winding 96 is used as the primary winding. The specific winding 96 (the primary winding) is connected to a converter 101 that converts a DC voltage from a DC power supply 104 into an AC voltage, and capacitors 102 and 103 are disposed between one terminal of the specific windings 96 and the converter 71.

The normal winding 95 (the secondary winding) is connected with a rectifier circuit 105. The normal winding 95 is provided with an intermediate tap 95c, and the intermediate tap 95c is connected to the ground.

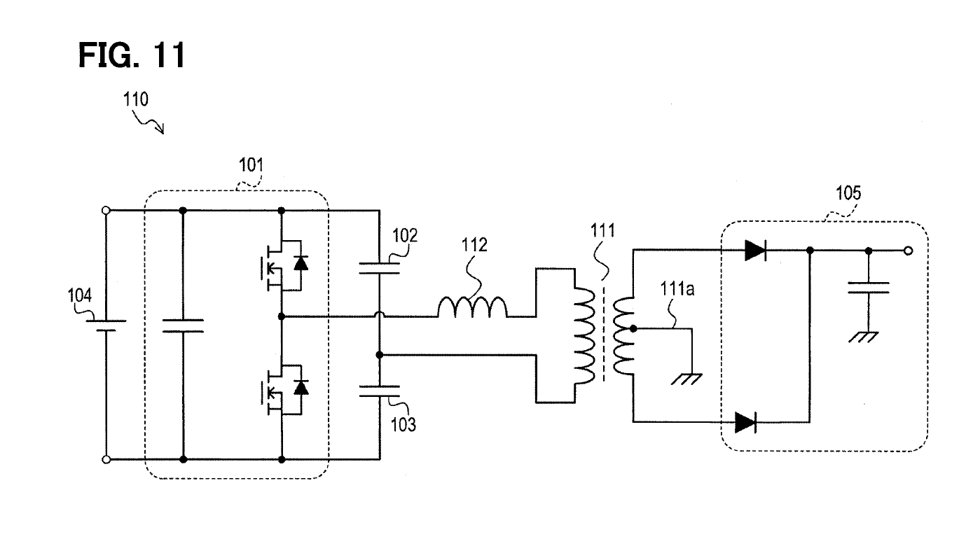

In an equivalent circuit 110 of the DC/DC converter 100, an inductor 112 is disposed between one terminal of the primary winding of a transformer 111, and the converter 101. Accordingly, an AC voltage of the sine wave is generated due to resonance generated between the inductor 112 and the capacitors 102 and 103 connected to the other terminal of the primary winding (see FIG. 11).

The normal winding 95 may be used as the primary winding, and the specific winding 96 may be used as the secondary winding to configure the same DC/DC converter.

### Fifth Embodiment

### Description of Main Configuration

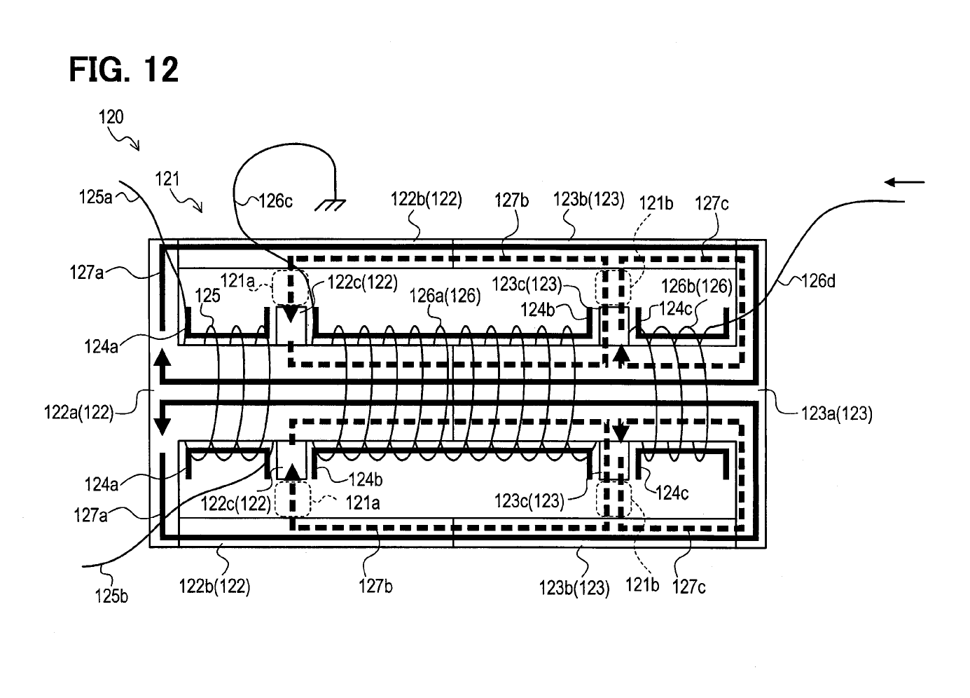

Subsequently, a transformer device 120 according to a fifth embodiment will be described (see FIG. 12). The transformer device 120 is also used in, for example, an ignition device for an internal combustion engine, a booster circuit in a liquid crystal monitor, a converter, an inverter, or a filter.

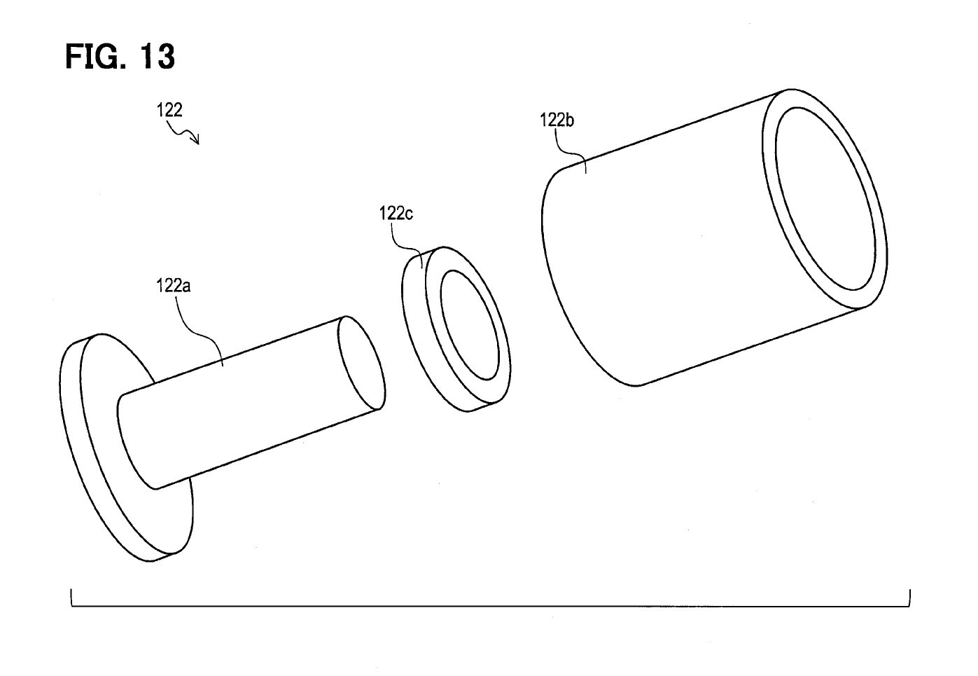

A magnetic core 121 of the transformer device 120 is integrated with a first base portion 122, a second base portion 123, and bobbins 124a to 124c. The first base portion 122 includes a shaft portion 122a, a cylindrical portion 122b, and a ring portion 122c (see FIG. 13).

The shaft portion 122a includes a columnar core portion, and a disk-shaped bottom portion disposed on one end of the column. The core portion projects from a center of the bottom portion in a direction orthogonal to a main surface of the bottom portion. The ring portion 122c is arranged in a state where the core portion of the shaft portion 122a penetrates through the ring portion 122c.

The shaft portion 122a has the core portion located inside of the cylindrical portion 122b, and the bottom portion covering one opening of the cylindrical portion 122b. As with the first base portion 122, the second base portion 123 includes a shaft portion 123a, a cylindrical portion 123b, and a ring portion 123c.

Gaps 121a and 121b are formed between the cylindrical portion 122b and the ring portion 122c of the first base portion 122, and between the cylindrical portion 123b and the ring portion 123c of the second base portion 123, respectively.

The first base portion 122 and the second base portion 123 are arranged in a state where opening sides (sides not covered with the bottom portions of the shaft portions 122a and 123a) come into contact with each other. In the magnetic core 121, the bobbins 124a to 124c are arranged on the core portions of the shaft portions 122a and 123a of the first and second base portions 122 and 123. The normal winding 125 and the specific winding 126 are arranged on the bobbins 124a to 124c.

Specifically, a section from the bottom portion to the ring portion 122c in the core portion of the shaft portion 122a in the first base portion 122 is equipped with the bobbin 124a, and the normal winding 125 is disposed on the bobbin 124a.

A bobbin 124b is disposed in a section of the core portions of the shaft portions 122a and 123a, which is sandwiched between the respective ring portions 122c and 123c, and an A section 126a of the specific winding 126 is disposed on the bobbin 124b.

The bobbin 124c is disposed in a section from the bottom portion to the ring portion 123c in the core portion of the shaft portion 123a in the second base portion 123, and the B section 126b of the specific winding 126 is disposed on the bobbin 124c.

The direction of winding the conductive wire is different between the A section 126a and the B section 126b. Specifically, for example, the orientation of the main magnetic path 127a is set to an orientation from the second base portion 123 toward the first base portion 122 in the core portion of the shaft portions 122a and 123a in the magnetic core 121. In this case, the A section 126a is formed by winding the conductive wire clockwise toward a direction of the main magnetic path 127a, and the B section 126b is formed by winding the conductive wire counterclockwise toward the direction. It is needless to say that the winding directions of the conductive wire in the A section 126a and in the B section 126b may be opposite to the directions described above.

The total number of turns of the conductive wire in the A section 126a is larger than the number of turns of the conductive wire in the B section 126b. In this situation, when a voltage is applied to the normal winding 125, as in the first embodiment, a magnetic flux that passes through the main magnetic path 127a is formed.

The main magnetic path 127a is formed on the magnetic core 121 along the shaft portions 122a, 123a, and the cylindrical portions 122b, 123b. An orientation of the main magnetic path 127a in FIG. 12 is indicated as an orientation of the magnetic flux that is generated when a current flowing from a first terminal 125a toward a second terminal 125b is supplied to the normal winding 125.

When a voltage is applied to the specific winding 126, as in the first embodiment, sub magnetic fluxes not interlinked with the normal winding 125 are formed in the A, B sections 126a,126b, respectively. In the fifth embodiment, an A sub-magnetic path 127b by the A section 126a, and a B sub-magnetic path 127c by the B section 126b are formed.

The A sub-magnetic path 127b is formed in a section sandwiched between the ring portions 122c, 123c of the magnetic core 121, and the ring portions 122c, 123c of the core portions of the shaft portions 122a, 123a, and the cylindrical portions 122b, 123b.

The B sub-magnetic path 127c is formed in a section defined by the ring portion 123c of the magnetic core 121, a bottom portion of the shaft portion 123a, the ring portion 123c in the core portion of the shaft portion 123a and the cylindrical portion 123b, and the bottom portion of the shaft portion 123a.

The orientations of the A, B sub-magnetic paths 127b, 127c in FIG. 12 are indicated as the orientation of the magnetic flux that is generated when the current flowing from the second terminal 126d toward the first terminal 126c is supplied to the specific winding 126.

In the transformer device 120 according to the fifth embodiment, in the A section 126a and the B section 126b of the specific winding 126, the winding direction of the winding is opposite to each other, and the number of turns is different from each other. The A, B sub-magnetic paths 127b, 127c are formed within the magnetic core 121 from the respective sections.

Accordingly, the same equivalent circuit as that in the first embodiment is also obtained in the transformer device 120, and in the equivalent circuit, the number of turns of the secondary winding in the transformer is smaller than the total number of turns of the specific winding 126.

Therefore, if the turn ratio of the primary winding and the secondary winding is the same, the number of turns of the primary winding can be reduced as compared with the transformer device of JP-A-2009-212157 in which the transformer and the inductance coil are integrated together on a single magnetic core.

As in the first embodiment, the total number of turns of the specific winding 126 in the transformer device 120 is equal to the number of turns of the inductor in the equivalent circuit, and the number of turns of the specific winding 126 does not increase by the configuration of the transformer device 120.

Furthermore, with the shape of the magnetic core 121, the leakage magnetic flux can be effectively prevented.

[Description of Other Configuration]

In the transformer device 120, the main magnetic path 127a is formed by the shaft portions 122a, 123a, and the cylindrical portions 122b, 123b, and a portion in which the main magnetic path 127a is shaped to surround all of the inner space of the magnetic core 121.

The A sub-magnetic path 127b is formed in a section sandwiched between the ring portions 122c, 123c of the magnetic core 121, and the ring portions 122c, 123c of the core portions of the shaft portions 122a, 123a, and the cylindrical portions 122b, 123b.

The B sub-magnetic path 127c is formed in a section defined by the ring portion 123c of the magnetic core 121, a bottom portion of the shaft portion 123a, the ring portion 123c in the core portion of the shaft portion 123a and the cylindrical portion 123b, and the bottom portion of the shaft portion 123a.

The portions where the sub-magnetic paths are formed are formed with the gaps, but are shaped to surround all of the inner spaces of the magnetic core 121. Accordingly, a leakage magnetic flux can be prevented from being generated from the magnetic core 121, and an electromagnetic interference can be suppressed.

Further, the main magnetic path 127a is arranged to surround the outer edges of the A, B sub-magnetic paths 127b, 127c. With this configuration, a risk that the leakage magnetic flux from the gaps disposed in the A, B sub-magnetic paths 127b, 127c electromagnetically interferes with an external circuit of the transformer device 120 can be further suppressed.

In the magnetic core 121, a portion where the normal winding 125 is arranged, and a portion where the specific winding 126 is arranged do not overlap with each other, and the sub-magnetic path is formed by each of the sections configuring the specific winding 126.

With the above configuration, all of the respective sections of the specific winding 126 function as an inductor, and the necessary inductance can be obtained while suppressing the number of turns of the specific winding 126. In the magnetic core 121, no gap is formed in the portion where the main magnetic path 127a is formed, but the gaps 121a and 121b are formed in the portions where the A, B sub-magnetic paths 127b, 127c are formed. Accordingly, a portion in which the main magnetic path 127a is formed is lower in magnetic resistance than portions in which the A, B sub-magnetic paths 127b, 127c are formed.

For example, the gaps 121a and 121b may be replaced with a material having a low permeability to increase the magnetic resistance of the A, B sub-magnetic paths 127b, 127c. As a result, as in the first embodiment, the magnetic saturation generated by the current flowing in the specific winding 126 can be suppressed.

Providing no gap in the main magnetic path 127a corresponds to an increase in the exciting inductance of the transformer in the equivalent circuit. As a result, a power factor in transmitting an electric power between the normal winding 125 and the specific winding 126 can increase, and an energy can be efficiently transmitted.

The magnitude of the ring portion 122c of the magnetic core 121 may correspond to the magnitude of the magnetic flux forming the A sub-magnetic path 127a. In other words, an area of a surface on the inner peripheral side in the ring portion 122c (a surface coming into contact with the shaft portion 122a) may have a size capable of sufficiently passing the maximum magnetic flux permitted in the A1 section 126a of the specific winding 126.

The magnitude of the ring portion 123c of the magnetic core 121 may correspond to the sum of the magnitude of the magnetic flux forming the A sub-magnetic path 127a, and the magnitude of the magnetic flux forming the B sub-magnetic path 127b.

In other words, when the maximum magnetic flux permitted in the A section 126a of the specific winding 126 and the maximum magnetic flux permitted in the B section 126b are generated at the same time, the area of the surface of the inner peripheral side in the ring portion 123c (a surface coming into contact with the shaft portion 123a) may have a size capable of sufficiently passing the magnetic fluxes.

With the above configuration, the magnetic saturation in the portion where the A, B sub-magnetic paths 127b, 127c are formed can be effectively suppressed. It is conceivable that, for example, the booster circuit used in an ignition plug of an internal combustion engine is configured by the transformer device 120, and the normal winding 125 is used as the primary winding, and the specific winding 126 is used as the secondary winding.

In this example, in the transformer device 120, the specific winding 126 has the first terminal 126c adjacent to the normal winding 125 and connected to the ground, and the second terminal 126d arranged on end side of the second base portion 123 and connected to the ignition plug.

Accordingly, in the booster circuit, the specific winding 126 is in a state where the first terminal having the potential closer to the potential of the normal winding 125 is arranged adjacent to the normal winding 125. With the above configuration, insulation between the normal winding 125 and the specific winding 126 can be more surely ensured.

The magnetic resistance of the portion in which the A, B sub-magnetic paths 127b, 127c are formed can be regulated according to the sizes of the gaps 121a and 121b, and the sizes of the cross-sectional areas. It is needless to say that the magnetic resistance can be regulated by replacing the gaps 121a and 121b with the material having a low permeability, or arranging such a material in a part of the magnetic core 121.

Under the circumstances, the magnetic resistances of the portion where the A, B sub-magnetic path 127b,127c are formed may be regulated so that the magnetic flux forming the A sub-magnetic path 127b and the magnetic flux forming the B sub-magnetic path 127c are similar to each other.

As a result, the magnetic saturation is uniformly generated in the portions, and more excellent DC bias characteristics can be obtained while suppressing an increase in the size of the magnetic core.

### Specific Example

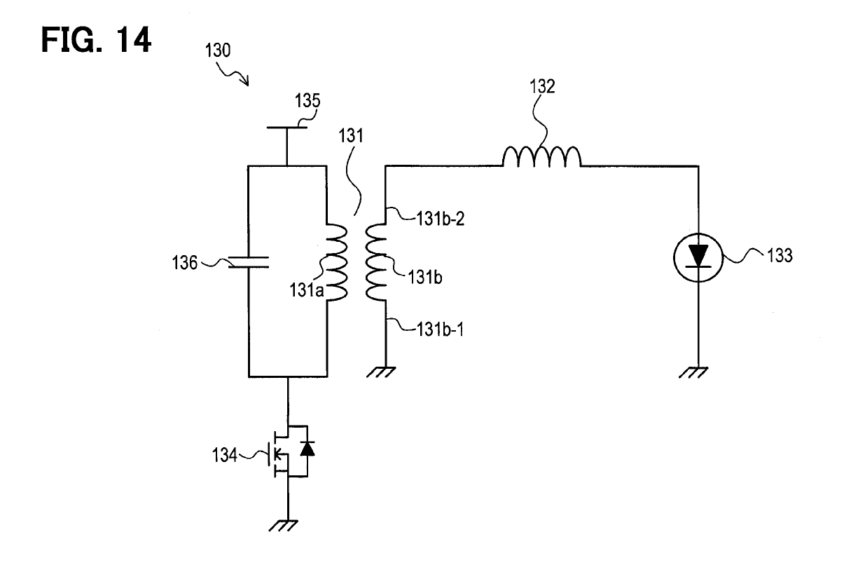

Subsequently, a description will be given of a specific example in which the transformer device 120 according to the fifth embodiment is applied to, for example, the booster circuit used in the ignition plug of the internal combustion engine. FIG. 14 illustrates an equivalent circuit 130 of the booster circuit using the transformer device 120.

In the booster circuit 130, the transformer device 120 has a normal winding 125 used as the primary winding, and a specified winding 126 used as the secondary winding. A voltage is applied to a primary winding 131a (the normal winding 125 of the transformer device 120) of the transformer 131 from a power supply 135 by an igniter 134 connected to the ground.

On the other hand, a first terminal 131b-1 of a secondary winding 131b (the specific winding 126 of the transformer device 120) is connected to the ground, and a second terminal 131b-2 is connected to an ignition plug 133 side. Accordingly, the voltage boosted by the transformer 131 is further boosted by oscillation generated between an inductor 132 on the secondary winding 131b side, and a capacitor 136 and a parasitic capacitor, and a high voltage is applied to the ignition plug 133.

In the booster circuit 130, the specific winding 126 is in a state where the first terminal having the potential closer to the potential of the normal winding 125 is arranged adjacent to the normal winding 125. With the above configuration, insulation between the normal winding 125 and the specific winding 126 can be more surely ensured.

### Sixth Embodiment

### Description of Main Configuration

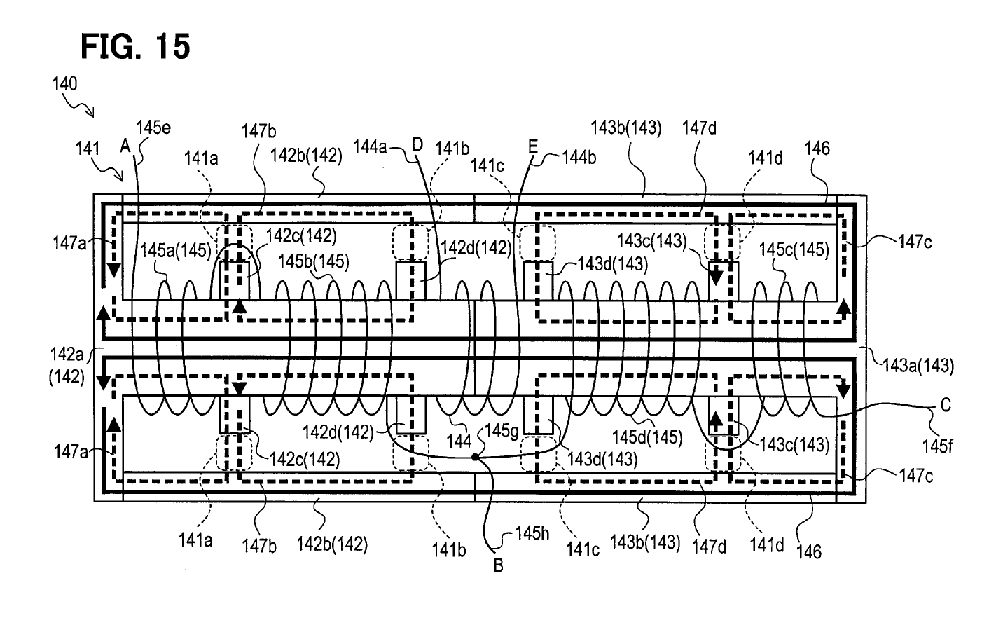

Subsequently, a transformer device 140 according to a sixth embodiment will be described (see FIG. 15). The transformer device 140 is also used in, for example, an ignition device for an internal combustion engine, a booster circuit in a liquid crystal monitor, a converter, an inverter, or a filter.

A magnetic core 141 of the transformer device 140 is integrated with a first base portion 142 and a second base portion 143. As in the fifth embodiment, the first base portion 142 includes a shaft portion 142a, a cylindrical portion 142b, and first and second ring portions 142c, 142d. However, this embodiment is different from the fifth embodiment in that the two ring portions 142c and 142d are provided in a state where a core portion of the shaft portion 142a penetrates through two ring portions 142c and 142d.

As with the first base portion 142, the second base portion 143 includes a shaft portion 143a, a cylindrical portion 143b, and first and second ring portions 143c, 143d. The first and second base portions 142 and 143 are arranged in the same manner as that of the fifth embodiment.

Gaps 141a to 141d are formed between the cylindrical portion 142b and the first and second ring portions 142c, 142d in the first base portion 142, and between the cylindrical portion 143b and the first and second ring portions 143c, 143d of the second base portion 143, respectively.

In the magnetic core 141, the normal winding 144 and the specific winding 145 are disposed on the core portion of the shaft portions 142a and 143a in the first and second base portions 142 and 143. Specifically, the normal winding 144 is disposed in the section sandwiched between the respective second ring portions 142d and 143d in the core portions of the shaft portions 142a and 143a.

The specific winding 145 is disposed in a section of the first base portion 142 from a bottom portion in the core portion of the shaft portion 142a to the second ring portion 142d, and a section of the second base portion 143 from the bottom portion in the core portion of the shaft portion 143a to the second ring portion 143d.

In more detail, a B1 section 145a of the specific winding 145 is disposed in the section of the first base portion 142 from the bottom portion in the core portion of the shaft portion 142a to the first ring portion 142c, and an A1 section 145b is disposed in the section from the first ring portion 142c to the second ring portion 142d.

In addition, a B2 section 145c of the specific winding 145 is disposed in the section of the second base portion 143 from the bottom portion in the core portion of the shaft portion 143a to the first ring portion 143c, and an A2 section 145d is disposed in the section from the first ring portion 143c to the second ring portion 143d.

Hereinafter, the A1, A2 sections 145b, 145d are also merely called “A section”, and the B1, B2 sections 145a, 145c are also merely called “B section”. A direction of winding the conductive wire is different between the A section and the B section.

Specifically, for example, the orientation of the main magnetic path 146 is set to an orientation from the second base portion 143 toward the first base portion 142 in the core portion of the shaft portions 142a and 143a in the magnetic core 141. In this case, the A section is formed by winding the conductive wire clockwise toward a direction of the main magnetic path 146, and the B section is formed by winding the conductive wire counterclockwise toward the direction. It is needless to say that the respective winding directions of the conductive wire in the A section and in the B section may be opposite to the directions described above.

The total number of turns of the conductive wire in the A section is larger than the number of turns of the conductive wire in the B section. An intermediate tap 145g is disposed in the conductive wire connecting the A1, A2 sections 145b, 145d, and the B terminal 145h connected to the intermediate tap 145g is connected to the ground.

In this situation, when a voltage is applied to the normal winding 144, as in the first embodiment, a magnetic flux that passes through the main magnetic path 146 is formed. The main magnetic path 146 is formed on the magnetic core 141 along the shaft portions 142a, 143a, and the cylindrical portions 142b, 143b. An orientation of the main magnetic path 146 in FIG. 15 is indicated as an orientation of the magnetic flux that is generated when a current flowing from a D terminal 144a toward an E terminal 144b is supplied to the normal winding 144.

When a voltage is applied to the specific winding 145, as in the first embodiment, sub magnetic fluxes not interlinked with the normal winding 144 are formed by the respective sections of the specific winding 145. In the sixth embodiment, an A1 sub-magnetic path 147b by the A1 section 145b, an A2 sub-magnetic path 147d by the A2 section 145d, a B1 sub-magnetic path 147a by the B1 section 145a, and a B2 sub-magnetic path 147c by the B2 section 145c are formed.

The A1 sub-magnetic path 147b is formed in a section sandwiched between the first and second ring portions 142c and 142d of the first base portion 142, and the ring portions 142c and 142d of the core portion of the shaft portion 142a, and the cylindrical portion 142b.

The A2 sub-magnetic path 147d is formed in a section sandwiched between the first and second ring portions 143c and 143d of the second base portion 143, and the first and second ring portions 143c and 143d of the core portion of the shaft portion 143a, and the cylindrical portion 143b.

The B1 sub-magnetic path 147a is formed in the first ring portion 142c in the first base portion 142, a section from the bottom portion of the shaft portion 142a to the first ring portion 142c, and a section from the bottom portion of the cylindrical portion 142b to the first ring portion 142c.

The B2 sub-magnetic path 147c is formed in the first ring portion 143c in the second base portion 143, a section from the bottom portion of the shaft portion 143a to the first ring portion 143c, and a section from the bottom portion of the cylindrical portion 143b to the first ring portion 143c.

The orientations of the A1 to B2 sub-magnetic paths 147a to 147d in FIG. 15 are indicated as the orientation of the magnetic flux that is generated when the current flowing from an A terminal 145e toward a C terminal 145f is supplied to the specific winding 145.

In the transformer device 140 according to the sixth embodiment, in the A, B sections of the specific winding 145, the winding direction of the winding is opposite to each other, and the number of turns is different from each other. The A1 to B2 sub-magnetic paths 147a to 147d are formed within the magnetic core 141 from the respective sections.

Accordingly, the same equivalent circuit as that in the first embodiment is obtained if the normal winding 144 of the transformer device 140 is used as the primary winding, and the specific winding 145 is used as the secondary winding, and in the equivalent circuit, the number of turns of the secondary winding of the transformer is smaller than the total number of turns of the specific winding 145 (the secondary winding).

Therefore, if the turn ratio of the primary winding and the secondary winding is the same, the number of turns of the primary winding can be reduced as compared with the transformer device of JP-A-2009-212157 in which the transformer and the inductance coil are integrated together on a single magnetic core.

As in the first embodiment, the total number of turns of the specific winding 145 (the secondary winding) in the transformer device 140 is equal to the number of turns of the inductor in the equivalent circuit, and the number of turns of the specific winding 145 (the secondary winding) does not increase by the configuration of the transformer device 140.

Furthermore, with the shape of the magnetic core 141, the leakage magnetic flux can be effectively prevented.

[Description of Other Configuration]

In the transformer device 140, the main magnetic path 146 is formed by the shaft portions 142a, 143a, and the cylindrical portions 142b, 143b, and a portion in which the main magnetic path 146 is formed is shaped to surround all of the inner space of the magnetic core 141.

The A1 sub-magnetic path 147b is formed in a section sandwiched between the first and second ring portions 142c and 142d of the first base portion 142, and the first and second ring portions 142c and 142d of the core portion of the shaft portion 142a, and the cylindrical portion 142b.

The A2 sub-magnetic path 147d is formed in a section sandwiched between the first and second ring portions 143c and 143d of the second base portion 143, and the first and second ring portions 143c and 143d of the core portion of the shaft portion 143a, and the cylindrical portion 143b.

The B1 sub-magnetic path 147a is formed in the first ring portion 142c in the first base portion 142, a section from the bottom portion of the shaft portion 142a to the first ring portion 142c, and a section from the bottom portion of the cylindrical portion 142b to the first ring portion 142c.

The B2 sub-magnetic path 147c is formed in the first ring portion 143c in the second base portion 143, a section from the bottom portion of the shaft portion 143a to the first ring portion 143c, and a section from the bottom portion of the cylindrical portion 143b to the first ring portion 143c.

The portions where the sub-magnetic paths are formed are formed with the gaps, but are shaped to surround all of the inner spaces of the magnetic core 141. Accordingly, a leakage magnetic flux can be prevented from being generated from the magnetic core 141, and an electromagnetic interference can be suppressed.

Further, the main magnetic path 146 is arranged to surround the outer edges of the A1 to B2 sub-magnetic paths 147a and 147d. With this configuration, a risk that the leakage magnetic flux from the gaps disposed in the A1 to B2 sub-magnetic paths 147a to 147d electromagnetically interferes with an external circuit of the transformer device 140 can be further suppressed.

In the magnetic core 141, a portion where the normal winding 144 is arranged, and a portion where the specific winding 145 is arranged do not overlap with each other, and the sub-magnetic path is formed by each of the sections configuring the specific winding 145.

With the above configuration, all of the respective sections of the specific winding 145 function as an inductor, and the necessary inductance can be obtained while suppressing the number of turns of the specific winding 145. In the magnetic core 141, no gap is formed in the portion where the main magnetic path 146 is formed, but the gaps 141a to 141d are formed in the portions where the A1 to B2 sub-magnetic paths 147a to 147d. Accordingly, a portion in which the main magnetic path 146 is formed is lower in magnetic resistance than portions in which the sub-magnetic paths are formed.

For example, the gaps 141a to 141d may be replaced with a material having a low permeability to increase the magnetic resistance of the portions in which the sub-magnetic paths are formed. As a result, as in the first embodiment, the magnetic saturation generated by the current flowing in the specific winding 145 can be suppressed.

In addition, by providing no gap in the main magnetic path 146, a power factor in transmitting an electric power between the normal winding 144 and the specific winding 145 can increase, and an energy can be efficiently transmitted.

The magnitude of the ring portion 142c of the first base portion 142 may correspond to the magnitude of the magnetic flux forming the A1, B1 sub-magnetic paths 147a and 147b. In other words, when the maximum magnetic flux permitted in the B1 section 145a of the specific winding 145 and the maximum magnetic flux permitted in the A1 section 145b are generated at the same time, the area of the surface on the inner peripheral side in the first ring portion 142c (a surface coming into contact with the shaft portion 142a) may have a size capable of sufficiently passing the magnetic fluxes.

The magnitude of the second ring portion 142d of the first base portion 142 may correspond to the magnitude of the magnetic flux forming the A1 sub-magnetic path 147b. In other words, an area of a surface on the inner peripheral side in the second ring portion 142d (a surface coming into contact with the shaft portion 142a) may have a size capable of sufficiently passing the maximum magnetic flux permitted in the A1 section 145b of the specific winding 145.

The magnitude of the first ring portion 143c of the second base portion 143 may correspond to the magnitude of the magnetic flux forming the A2, B2 sub-magnetic paths 147c, 147d. In other words, when the maximum magnetic flux permitted in the B2 section 145c of the specific winding 145 and the maximum magnetic flux permitted in the A2 section 145d are generated at the same time, the area of the surface (surface abutted against the shaft portion 143a) on the inner peripheral side in the first ring portion 143c may have a size capable of sufficiently passing the magnetic fluxes.

The magnitude of the second ring portion 143d of the second base portion 143 may correspond to the magnitude of the magnetic flux forming the A2 sub-magnetic path 147d. In other words, an area of a surface (surface abutted against the shaft portion 143a) on the inner peripheral side in the second ring portion 143d may have a size capable of sufficiently passing the maximum magnetic flux permitted in the A2 section 145d of the specific winding 145.

With the above configuration, the magnetic saturation in the portion where the A1 to B2 sub-magnetic paths 147a to 147d are formed can be effectively suppressed. In the transformer device 140, the intermediate tap 145g of the secondary winding 145 connected to the ground is disposed in the vicinity of the normal winding 144.

As a result, when the potentials of the D, E terminals 144a, 144b of the normal winding 144 are closer to the ground than the potential of the A, C terminals 145e, 145f of the specific winding 145, insulation between the normal winding 144 and the specific winding 145 can be more surely ensured.

The magnetic resistance of the portions in which the A1 to B2 sub-magnetic paths 147a to 147d are formed can be regulated according to the sizes of the gaps 141a to 141d, and the sizes of the cross-sectional areas. It is needless to say that the magnetic resistance can be regulated by replacing the gaps 141a to 141d with the material having a low permeability, or arranging such a material in a part of the magnetic core 141.

Under the circumstances, the magnetic resistances of the portion where the A1 to B2 sub-magnetic paths 147a to 147d are formed may be regulated so that the magnetic fluxes forming the A1 to B2 sub-magnetic paths 147a to 147d are similar to each other.

As a result, the magnetic saturation is uniformly generated in the portions, and more excellent DC bias characteristics can be obtained while suppressing an increase in the size of the magnetic core.

### Specific Example

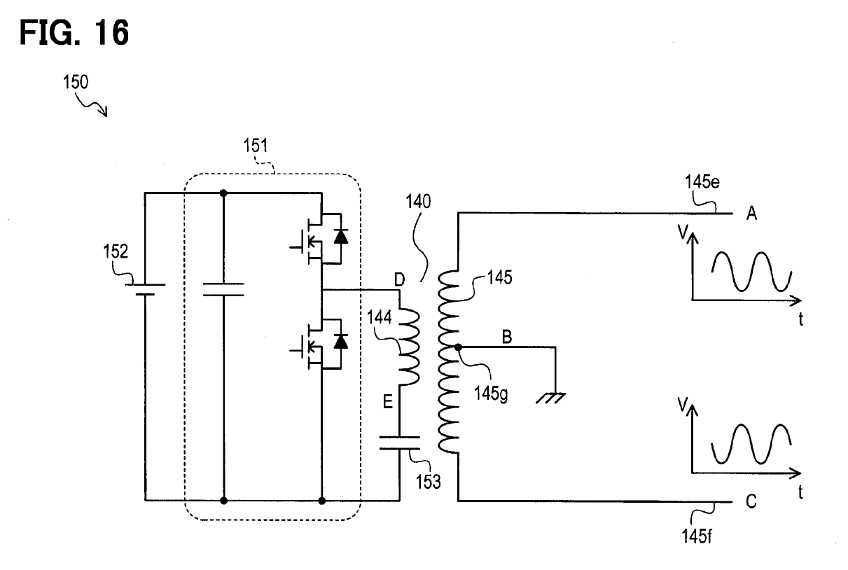

Subsequently, a description will be given of a specific example in which the transformer device 140 according to the sixth embodiment is applied to an inverter 150 (see FIG. 16).

In the inverter 150, the normal winding 144 of the transformer device 140 is used as the primary winding, and the specified winding 145 of the transformer device 140 is used as the secondary winding. An AC voltage is applied to the normal winding 144 (the primary winding) by an input circuit 151 that converts a DC voltage generated by a power supply 152 into an AC voltage.

In addition, an E terminal of the normal winding 144 (the primary winding) is connected with a capacitor 153, and resonance is generated by an inductor formed by the specific winding 145 (the secondary winding) and the capacitor 153 to generate an AC voltage of a sine wave.

An intermediate tap 145g is disposed in the specific winding 145 (the secondary winding), and the B terminal connected to the intermediate tap 145g is connected to the ground. Accordingly, AC voltages of the sine wave shifted in phase by 180° are output from an A terminal 145e and a C terminal 145f of the specific winding 145 (the secondary winding).

Instead of the specific winding 145, an intermediate tap may be disposed in the normal winding 144, and the specific winding 145 may be used as the primary winding, and the normal winding 144 may be used as the secondary winding to form the same inverter.

### Seventh Embodiment

### Description of Main Configuration

Subsequently, a transformer device 160 according to a seventh embodiment will be described (see FIG. 16). The transformer device 160 is also used in, for example, an ignition device for an internal combustion engine, a booster circuit in a liquid crystal monitor, a converter, an inverter, or a filter.

A magnetic core 161 of the transformer device 160 is formed in a rod shape. A normal winding 162 is disposed adjacent to one end of the magnetic core 161. A specific winding 163 is disposed between the normal winding 162 and the other end of the magnetic core 161, and an A section 163a of the specific winding 163 is arranged in a center portion of the magnetic core 161 while a B section 163b of the specific winding 163 is arranged on the other end side of the magnetic core 161.

A direction of winding the conductive wire is different between the A section and the B section. Specifically, for example, in the magnetic core 161, an orientation of a main magnetic path 146 is set to an orientation from an arrangement position of the B section 163b toward an arrangement position of the normal winding 162. In this case, the A section 163a is formed by winding the conductive wire clockwise toward a direction of the main magnetic path 164, and the B section 163b is formed by winding the conductive wire counterclockwise toward the direction. It is needless to say that the respective winding directions of the conductive wire in the A section 163a and in the B section 163b may be opposite to the directions described above.

The total number of turns of the conductive wire in the A section 163a is larger than the number of turns of the conductive wire in the B section 163b. In this situation, when a voltage is applied to the normal winding 162, as in the first embodiment, a magnetic flux that passes through the main magnetic path 164 is formed.

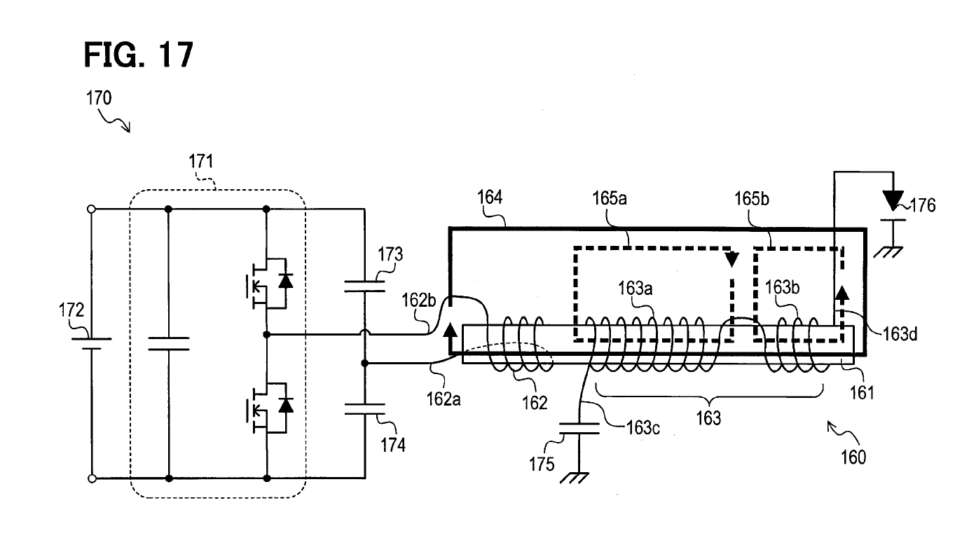

The main magnetic path 164 is formed in the magnetic core 161, and a space adjacent to the magnetic core 161. An orientation of the main magnetic path 164 in FIG. 17 is indicated as an orientation of the magnetic flux that is generated when a current flowing from a first terminal 162a toward a second terminal 162b is supplied to the normal winding 162.

When a voltage is applied to the specific winding 163, as in the first embodiment, sub magnetic fluxes not interlinked with the normal winding 162 are formed in the A, B sections 163a, 163b, respectively. The A sub-magnetic path 165a is formed in a section of the magnetic core 161 where the A section 163a is provided, and a space adjacent to the section.

The B sub-magnetic path 165b is formed in a section of the magnetic core 161 where the B section 163b is provided, and a space adjacent to the section. The orientations of the A, B sub-magnetic paths 165a, 165b in FIG. 17 are indicated as the orientation of the magnetic flux that is generated when the current flowing from the first terminal 163c toward the second terminal 163d is supplied to the specific winding 145.

In the transformer device 160 according to the seventh embodiment, in the A section 163a and the B section 163b of the specific winding 163, the winding direction of the winding is opposite to each other, and the number of turns is different from each other. The A, B sub-magnetic paths 165a, 165b are formed from the respective sections.

Accordingly, the same equivalent circuit as that in the first embodiment is obtained if the normal winding 162 of the transformer device 160 is used as the primary winding, and the specific winding 163 is used as the secondary winding, and in the equivalent circuit, the number of turns of the secondary winding of the transformer is smaller than the total number of turns of the specific winding 163 (the secondary winding).

Therefore, if the turn ratio of the primary winding and the secondary winding is the same, the number of turns of the primary winding can be reduced as compared with the transformer device of JP-A-2009-212157 in which the transformer and the inductance coil are integrated together on a single magnetic core.

As in the first embodiment, the total number of turns of the specific winding 163 (the secondary winding) in the transformer device 160 is equal to the number of turns of the inductor in the equivalent circuit, and the number of turns of the specific winding 163 (the secondary winding) does not increase by the configuration of the transformer device 160.

[Description of Other Configuration]

In the magnetic core 161 of the transformer device 160, a portion where the normal winding 162 is arranged, and a portion where the specific winding 163 is arranged do not overlap with each other, and the sub-magnetic path is formed by each of the sections configuring the specific winding 163.

With the above configuration, all of the respective sections of the specific winding 163 function as an inductor, and the necessary inductance can be obtained while suppressing the number of turns of the specific winding 163. It is preferable that the transformer device 160 is configured so that a potential closer to the potential of the normal winding 162 than the second terminal 163d is generated in the first terminal 163c of the specific winding 163.

Specifically, for example, if a voltage applied to the normal winding 162 (the primary winding) is boosted with the use of the transformer device 160 for a booster circuit of an ignition device for an internal combustion engine, it is preferable that the first terminal 163c of the specific winding 163 (the secondary winding) is connected to the ground side, the second terminal 163d is connected to an ignition plug, and a high voltage is generated in the second terminal 163d.

With the above configuration, insulation between the normal winding 162 (the primary winding) and the specific winding 163 (the secondary winding) can be more surely ensured.

### Specific Example

Subsequently, a description will be given of a specific example in which the transformer device 160 according to the seventh embodiment is applied to a booster circuit 170 (see FIG. 17).

In the booster circuit 170, the normal winding 162 of the transformer device 160 is used as the primary winding, and the specified winding 163 of the transformer device 160 is used as the secondary winding. An AC voltage is applied to the second terminal 162b of the normal winding 162 (the primary winding) by an input circuit 171 that converts a DC voltage generated by a power supply 172 into an AC voltage.

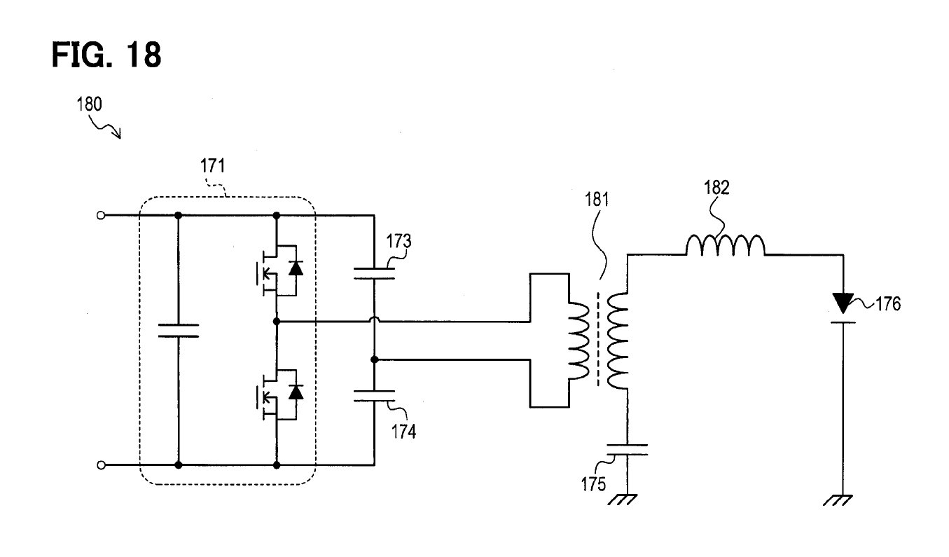

Capacitors 173 and 174 are connected to the first terminal 162a of the normal winding 162 (the primary winding). In an equivalent circuit 180 of the booster circuit 170, an inductor 182 is disposed in the secondary winding side of the transformer 181 (see FIG. 18).

Accordingly, resonance is generated between the inductor 182, and the capacitors 173 and 174 connected to the primary winding, or the capacitor 175 connected to the first terminal 163c of the specific winding 163 (the secondary winding), and a voltage boosted by the transformer 181 is further boosted, and is applied to the discharge plug 176.

The capacitor 175 connected to the first terminal 163c of the specific winding 163 (the secondary winding) may not be provided.

### Other Embodiments

In the transformer device according to the first to seventh embodiments, the sub-magnetic paths are formed by the respective sections of the specific winding. However, a section in which the sub-magnetic path is not formed may be present, and the same advantages can be obtained if at least one sub-magnetic path is formed by the specific winding.

Specifically, for example, if the specific winding including two of the A section and the B section is used, all or a part of one of the sections may be arranged to overlap with the normal winding, and the sub-magnetic path may be formed by only the other section.

In the case using the same specific winding, the A section and the B section may be arranged to overlap with each other, and the sub-magnetic path may be formed by the sections. Even in this case, the same advantages can be obtained.

What is claimed is:

1. A transformer device comprising:
a magnetic core configured by a single part or configured integrally by a plurality of parts;
a normal winding having a conductive wire wound around the magnetic core;
a main magnetic path interlinked with the normal winding; and
a specific winding including one or a plurality of A sections formed on the main magnetic path by winding a conductive wire around the magnetic core toward a predetermined direction, and one or a plurality of B sections formed on the main magnetic path by winding the conductive wire around the magnetic core toward a direction opposite to the direction in the A sections,
wherein the a total number of turns of the conductive wire in all of the A sections is different from a total number of turns of the conductive wire in all of the B sections, and
wherein at least one section in the specific winding is arranged to form a sub-magnetic path which is a magnetic path not interlinked with the normal winding.

2. The transformer device according to claim 1,
wherein the magnetic core includes a main closed magnetic path portion having a shape surrounding an internal space, and a sub-closed magnetic path portion having the shape or the shape including a gap,
wherein the normal winding and respective sections of the specific winding are arranged so that the main magnetic path is formed along the main closed magnetic path portion, and
wherein the respective sections of the specific winding are arranged so that the sub-magnetic path is formed along the sub-closed magnetic path portion.

3. The transformer device according to claim 2,
wherein the main closed magnetic path portion is arranged to surround an outer edge of an assembly of the sub-closed magnetic path portion.

4. The transformer device according to claim 1,
wherein all of the sections of the specific winding are arranged so that the sub-magnetic path is formed from the sections.

5. The transformer device according to claim 1,
wherein the magnetic core is configured so that a magnetic resistance of the main magnetic path is lower than a magnetic resistance of the sub-magnetic path.

6. The transformer device according to claim 1,
wherein the magnetic core is configured so that a cross-sectional area of a portion of the magnetic core in which one or a plurality of the sub-magnetic paths are formed has a size corresponding to a sum of intensities of magnetic fluxes in the sub-magnetic paths formed in the portion.

7. The transformer device according to claim 1,
wherein one of ends of the specific winding in which a potential closer to a potential of the normal winding is generated is set as a first potential side, and the other end of the specific winding is set as a second potential side, and
wherein the normal winding and the specific winding are arranged so that the first potential side of the specific winding comes closer to the normal winding than the second potential side.

8. The transformer device according to claim 1,
wherein the magnetic core includes a cylindrical outer peripheral portion, and a rod-shaped shaft portion configured integrally with the outer peripheral portion and arranged inside of the outer peripheral portion, and
wherein the normal winding and the specific winding are disposed on the shaft portion.

9. The transformer device according to claim 8,
wherein one of ends of the specific winding in which a potential closer to a potential of the normal winding is generated is set as a first potential side, and the other end of the specific winding is set as a second potential side,
wherein the normal winding is arranged adjacent to one end of the shaft portion, and
wherein the specific winding is arranged so that the first potential side comes closer to the normal winding than the second potential side.

10. The transformer device according to claim 1,
wherein at least two of the sections in the specific winding are arranged to form the sub-magnetic path, and
wherein magnetic resistances of respective portions of the magnetic core in which the sub-magnetic paths are formed are regulated so that intensities of the magnetic fluxes generated in the respective sub-magnetic paths are similar to each other.
